(19) United States
(12) Patent Application Publication
(10) Pub. No.: US 2010/0210296 A1
(43) Pub. Date: Aug. 19, 2010

(54) Radio Base Station and Transmission Control Method

(75) Inventor: Satoshi Kawaji, Kanagawa (JP)

Correspondence Address: Hogan Lovells US LLP, 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/597,734

(22) PCT Filed: Apr. 25, 2008
(86) PCT No.: PCT/JP2008/058151

§ 371 Date: May 3, 2010

(30) Foreign Application Priority Data
Apr. 26, 2007 (JP) 2007-117793
May 29, 2007 (JP) 2007-142580

(51) Int. Cl. H04B 7/005

(52) U.S. Cl. 455/522

(57) ABSTRACT

A transmission control method according to the present invention includes: step S1104 of judging whether a sum of transmission power at timing of transmitting radio signals to the plurality of radio communication terminals reaches a threshold; step S1106 of judging whether it is possible to reduce the transmission power of a radio signal to be transmitted to a second radio communication terminal when the sum is judged to reach the threshold; and step S1108 of reducing the transmission power of the radio signal to be transmitted to the second radio communication terminal and increasing the transmission power of a radio signal to be transmitted to a first radio communication terminal, when it is judged that it is possible to reduce the transmission power of the radio signal to be transmitted to the second radio communication terminal.

### TECHNICAL FIELD

The present invention relates to a radio base station and a transmission control method for transmitting radio signals simultaneously to multiple radio communication terminals including a first radio communication terminal and a second radio communication terminal.

### BACKGROUND ART

Adaptive modulation has heretofore been known as a technique to enhance a communication rate in a radio communication system. In a radio communication system using the adaptive modulation, a radio base station communicates with a radio communication terminal by using a modulation class having a high communication rate when quality of a radio propagation path with the radio communication terminal (hereinafter “propagation path quality”) is high.

The orthogonal frequency division multiplexing access (OFDMA) is known as a communication method that uses numerous subcarriers. In a radio communication system using the OFDMA, a different modulation class can be applied to each subcarrier (see Patent Document 1).

In a method according to Patent Document 1, a radio communication terminal measures reception quality of a radio signal transmitted from a radio base station for each subcarrier, and notifies the radio base station of the measured reception quality. The radio base station selects the subcarrier to be used for communication with the radio communication terminal in accordance with the reception quality of each of the subcarriers notified by the radio communication terminal. In this way, the radio communication terminal can use a modulation class having a higher communication rate.

Patent Document 1: JP-A 2003-304214 (page 6)

### DISCLOSURE OF THE INVENTION

In order to improve the reception quality of the radio signal, it is desirable to increase transmission power of the radio signal at the radio base station. Therefore, it is conceivable to increase the transmission power for a radio communication terminal which has low reception quality of the radio signal and which requests high-speed communication.

However, when the radio base station transmits radio signals to multiple radio communication terminals at the same time, there may be a case where an amplifier in a transmitter of the radio base station is close to saturation. In this case, even if the radio base station receives a request for increasing the transmission power from a radio communication terminal, the radio base station cannot increase the transmission power of the radio signal to be transmitted to the radio communication terminal. Meanwhile, under a situation where the amplifier in the transmitter of the radio base station is close to saturation, the following problem occurs when communication at a low data rate (data quantity) is executed between the radio base station and a certain radio communication terminal, or when a downlink CNR in the radio communication terminal is higher than a CNR required for a modulation class applied to a radio signal to be transmitted to the radio communication terminal.

Specifically, when the radio communication terminal is located near the radio base station, the propagation path quality between the radio communication terminal and the radio base station is high. Accordingly, the transmission power from the radio base station to the radio communication terminal is increased more than necessary though the communication is executed at the low data rate.

Meanwhile, the transmission power from the radio base station to the radio communication terminal is also increased more than necessary when the downlink CNR at the radio communication terminal is higher than the CNR required for the modulation class applied to the radio signal to be transmitted to the radio communication terminal.

This is extremely wasteful power control under the situation where the amplifier in the transmitter of the radio base station is close to saturation. Moreover, the radio communication terminal consumes excessive power for reception processing of data transmitted at excessive transmission power from the radio base station in this case. As a consequence, an excessive processing load is applied to the radio communication so terminal.

In summary, when the radio base station transmits radio signals to the multiple radio communication terminals at the same time, the conventional technique has a problem that the transmission power is not properly controlled for the multiple radio communication terminals when the amplifier in the transmitter of the radio base station is close to saturation.

In view of the above-mentioned problem, a first object of the present invention is to provide a radio base station and a transmission control method which are capable of increasing transmission power of a radio signal to be transmitted to a radio communication terminal having low reception quality, even when an amplifier in a transmitter of the radio base station is close to saturation.

Meanwhile, a second object of the present invention is to provide a radio base station and a transmission control method which are capable of properly controlling transmission power for multiple radio communication terminals even when an amplifier in a transmitter of the radio base station is close to saturation.

To accomplish the first object above, a first characteristic of the present invention is summarized as a radio base station (radio base station 1100) which transmits radio signals simultaneously to a plurality of radio communication terminals including a first radio communication terminal (radio terminal #2) and a second radio communication terminal (radio terminal #1). The radio base station includes: an increase request receiver (request receiver 1144) configured to receive, from the so first radio communication terminal, an increase request for transmission power of a radio signal to be transmitted to the first radio communication terminal; a threshold judgment unit (transmission power judgment unit 1145) configured to judge whether a sum of the transmission power at timing of transmitting the radio signals to the radio communication terminals reaches a threshold, when the increase request receiver receives the increase request; a reduction judgment unit (transmission power judgment unit 1145) configured to judge whether it is possible to reduce the transmission power of a radio signal to be transmitted to the second radio communication terminal, when the threshold judgment unit judges that the sum reaches the threshold; and a transmission power controller (transmission power controller 1147) configured to reduce the transmission power of the radio signal to be transmitted to the second radio communication terminal and to increase the transmission power of the radio signal to be transmitted to the first radio communication terminal, when the reduction judgment unit judges that it is possible to reduce the transmission power of the radio signal to be transmitted to the second radio communication terminal.

According to this aspect, when it is judged that the sum of the transmission power at the timing of transmitting the radio signals to the multiple radio communication terminals reaches the threshold and that the transmission power of the radio signal to be transmitted to the second radio communication terminal can be reduced, the radio base station reduces the transmission power of the radio signal to be transmitted to the second radio communication terminal and increases the transmission power of the radio signal to be transmitted to the first radio communication so terminal. Therefore, even when the amplifier in the transmitter of the radio base station is close to saturation, it is possible to increase the transmission power of the radio signal to be transmitted to the radio communication terminal having low reception quality (first radio communication terminal).

A second characteristic of the present invention is according to the first characteristic of the present invention, and is summarized as further comprising: a reception quality acquisition unit (reception quality acquisition unit 1141) configured to acquire reception quality of the radio signal (CNR) received by each of the radio communication terminals; and a modulation class determination unit (modulation class determination unit 1142) configured to determine a modulation class to be applied to the radio signal to be transmitted to each of the radio communication terminals in accordance with the reception quality acquired by the reception quality acquisition unit.

A third characteristic of the present invention is according to the second characteristic of the present invention, and is summarized in that the reduction judgment unit judges that it is possible to reduce the transmission power of the radio signal to be transmitted to the second radio communication terminal, when the reception quality of the radio signal received by the second radio communication terminal is higher than required reception quality (required CNR) of the modulation class applied to the radio signal to be transmitted to the second radio communication terminal.

A fourth characteristic of the present invention is according to the first characteristic of the present invention, and is summarized as further comprising an interference judgment unit (interference judgment unit 1146) configured to judge whether the radio signal to be transmitted to the first radio communication terminal will interfere with a radio communication terminal communicating with a different radio base station, if the transmission power of the radio signal to be transmitted to the first radio communication terminal is increased. The transmission power controller increases the transmission power of the radio signal to be transmitted to the first radio communication terminal, when the interference judgment unit judges that the radio signal to be transmitted to the first radio communication terminal will not interfere with the radio communication terminal communicating with the different radio base station.

A fifth characteristic of the present invention is summarized as a transmission control method using a radio base station which transmits radio signals simultaneously to a plurality of radio communication terminals including a first radio communication terminal and a second radio communication terminal. The transmission control method comprising the steps of: receiving, from the first radio communication terminal, an increase request for transmission power of a radio signal to be transmitted to the first radio communication terminal (step S1103); judging whether a sum of the transmission power at timing of transmitting the radio signals to the radio communication terminals reaches a threshold, when receiving the increase request (step S1104); judging whether it is possible to reduce the transmission power of a radio signal to be transmitted to the second radio communication terminal, when the sum is judged to reach the threshold (step S1106); reducing the transmission power of the radio signal to be transmitted to the second radio communication terminal, when it is judged that it is possible to reduce the transmission power of the radio signal to be transmitted to the second radio communication terminal (step S1108); and increasing the transmission power of the radio signal to be transmitted to the first radio communication terminal after reducing the transmission power of the radio signal to be transmitted to the second radio communication terminal (step S1108). To accomplish the second object above, a sixth characteristic of the present invention is summarized as a radio base station (radio base station 2100) which transmits radio signals simultaneously to a plurality of radio communication terminals including a first radio communication terminal (radio terminal #1) and a second radio communication terminal (radio terminal #2). The radio base station comprising: a reduction judgment unit (transmission power judgment unit 2145) configured to judge whether it is possible to reduce transmission power of a radio signal to be transmitted to the first radio communication terminal; a threshold judgment unit (transmission power judgment unit 2145) configured to judge whether a sum of the transmission power at timing of transmitting the radio signals to the radio communication terminals reaches a threshold, when the reduction judgment unit judges that it is possible to reduce the transmission power of the radio signal to be transmitted to the first radio communication terminal; an increase judgment unit (transmission power judgment unit 2145) configured to judge whether it is possible to increase the transmission power of a radio signal to be transmitted to the second radio communication terminal, when the threshold judgment unit judges that the sum reaches the threshold; and a transmission power controller (transmission power controller 2147) configured to reduce the transmission power of the radio signal to be transmitted to the first radio communication terminal, when the increase judgment unit judges that it is possible to increase the transmission power of the radio signal to be transmitted to the second radio communication terminal and when the transmission power of the radio signal to be transmitted to the second radio communication terminal is increased.

According to these, aspects, the radio base station can reduce the transmission power of the radio signal to be transmitted to the first radio communication terminal. In this case, when the sum of the transmission power at timing of transmitting the radio signals to the multiple radio communication terminals (including first radio communication terminal and second radio communication terminal) reaches the threshold, it is possible to reduce the transmission power of the radio signal to be transmitted to the first radio communication terminal and to increase the transmission power of the radio signal to be transmitted to the second radio communication terminal. Therefore, even when the amplifier in the transmitter of the radio base station is close to saturation, it is possible to increase the transmission power of the radio signal to be transmitted to the radio communication terminal having low reception quality (second radio communication terminal), and moreover, to reduce the transmission power of the radio signal to be transmitted to the radio communication terminal which executes communication at a low data rate.

A seventh characteristic of the present invention is according to the sixth characteristic of the present invention, and is summarized as further comprising a reduction request receiver (request receiver 2144) configured to receive, from the first radio communication terminal, a reduction request (including notification notifying that it is possible to reduce the transmission power) for the transmission power of the radio signal to be transmitted to the first radio communication terminal. The reduction judgment unit judges that it is possible to reduce the transmission power of the radio signal to be transmitted to the first radio communication terminal when the reduction request receiver receives the reduction request.

A eighth characteristic of the present invention is according to the sixth characteristic of the present invention, and is summarized as further comprising: a reception quality acquisition unit (reception quality acquisition unit 2141) configured to acquire reception quality of the radio signal received by each of the radio communication terminals; and a modulation class determination unit (modulation class determination unit 2142) configured to determine a modulation class to be applied to the radio signal to be transmitted to each of the radio communication terminals in accordance with the reception quality acquired by the reception quality acquisition unit. The reduction judgment unit judges that it is possible to reduce the transmission power of the radio signal to be transmitted to the first radio communication terminal, when the reception quality of the radio signal received by the first radio communication terminal is higher than required reception quality (required CNR) of the modulation class applied to the radio signal to be transmitted to the first radio communication terminal.

A ninth characteristic of the present invention is according to the sixth characteristic of the present invention, and is summarized as further comprising an increase notifier (increase notifier 2148) configured to notify the second radio communication terminal of a judgment result when the increase judgment unit judges that it is possible to increase the transmission power of the radio signal to be transmitted to the second radio communication terminal. The transmission power controller increases the transmission power of the radio signal to be transmitted to the second radio communication terminal and reduces the transmission power of the radio signal to be transmitted to the first radio communication terminal, when the transmission power controller receives from the second radio communication terminal an increase request for the transmission power of the radio signal to be transmitted to the second radio communication terminal as a result of the notification by the increase notifier.

A tenth characteristic of the present invention is according to the sixth characteristic of the present invention, and is summarized as further comprising an interference judgment unit (interference judgment unit 2146) configured to judge whether the radio signal to be transmitted to the second radio communication terminal will interfere with a radio communication terminal communicating with a different radio base station, if the transmission power of the radio signal to be transmitted to the second radio communication terminal is increased. The transmission power controller increases the transmission power of the radio signal to be transmitted to the second radio communication terminal, when the interference judgment unit judges that the radio signal to be transmitted to the second radio communication terminal will not interfere with the radio communication terminal communicating with the different radio base station.

A eleventh characteristic of the present invention is summarized as a transmission control method using a radio base station which transmits radio signals simultaneously to a plurality of radio communication terminals including a first radio communication terminal and a second radio communication terminal. The transmission control method comprising the steps of: judging whether it is possible to reduce transmission power of a radio signal to be transmitted to the first radio communication terminal (step S2102); judging whether it is possible to increase the transmission power of a radio signal to be transmitted to the second radio communication terminal if it is judged as a result of the judgment that it is possible to reduce the transmission power of the radio signal to be transmitted to the first radio communication terminal, and when a sum of the transmission power at timing of transmitting the radio signals to the radio communication terminals reaches a threshold (step S2105); and reducing the transmission power of the radio signal to be transmitted to the first radio communication terminal if it is judged as a result of the judgment that it is possible to increase the transmission power of the radio signal to be transmitted to the second radio communication terminal, and when the transmission power of the radio signal to be transmitted to the second radio communication terminal is increased (step S2109).

According to the first to fifth aspects of the present invention, it is possible to provide the radio base station and the transmission control method which are capable of increasing the transmission power of the radio signal to be transmitted to the radio communication terminal having low reception quality even when the amplifier in the transmitter of the radio base station is close to saturation. Meanwhile, according to the sixth to eleventh aspects of the present invention, it is possible to control the transmission power for the multiple radio communication terminals properly even when the amplifier in the transmitter of the radio base station is close to saturation.

### BRIEF DESCRIPTION OF THE DRAWINGS

FIG. 1 is an overall schematic configuration diagram of a radio communication system according to a first embodiment of the present invention.

FIG. 2 is a view showing an example of a state of burst assignment to a radio terminal according to the first embodiment of the present invention.

FIG. 3 is a view showing relations among a distance from a radio base station, modulation classes, and a required CNR according to the first embodiment of the present invention.

FIG. 4 is a functional block diagram showing an overall schematic configuration of the radio base station according to the first embodiment of the present invention.

FIG. 5 is a functional block diagram showing detailed configurations of a controller and a storage unit according to the first embodiment of the present invention.

FIG. 6 is a view showing various tables stored in the storage unit according to the first embodiment of the present invention.

FIG. 7 is a view for explaining transmission power control processing executed by the radio base station according to the first embodiment of the present invention.

FIG. 8 is a view for explaining interference attributable to an increase in the transmission power by the radio base station according to the first embodiment of the present invention.

FIG. 9 is a view showing a method of avoiding interference (pattern 2) in the radio base station according to the first embodiment of the present invention.

FIG. 10 is a view showing a method of avoiding interference (pattern 3) in the radio base station according to the first embodiment of the present invention.

FIG. 11 is a flowchart showing an overall operation of the radio base station according to the first embodiment of the present invention.

FIG. 12 is a flowchart showing an interference judgment operation of the radio base station according to the first embodiment of the present invention.

FIG. 13 is an overall schematic configuration diagram of a radio communication system according to a second embodiment of the present invention.

FIG. 14 is a view showing an example of a state of burst assignment to a radio terminal according to the second embodiment of the present, invention.

FIG. 15 is a view showing relations among a distance from a radio base station, modulation classes, and a required CNR according to the second embodiment of the present invention.

FIG. 16 is a functional block diagram showing an overall schematic configuration of the radio base station according to the second embodiment of the present invention.

FIG. 17 is a functional block diagram showing detailed configurations of a controller and a storage unit according to the second embodiment of the present invention.

FIG. 18 is a view showing various tables stored in the storage unit according to the second embodiment of the present invention.

FIG. 19 is a view for explaining transmission power control processing executed by the radio base station according to the second embodiment of the present invention.

FIG. 20 is a view for explaining interference attributable to an increase in the transmission power by the radio base station according to the second embodiment of the present invention.

FIG. 21 is a view showing a method of avoiding interference (pattern 2) in the radio base station-according to the second embodiment of the present invention.

FIG. 22 is a view showing a method of avoiding interference (pattern 3) in the radio base station according to the second embodiment of the present invention.

FIG. 23 is a flowchart showing an overall operation of the radio base station according to the second embodiment of the present invention.

FIG. 24 is a flowchart showing an interference judgment operation of the radio base station according to the second embodiment of the present invention.

### BEST MODES FOR CARRYING OUT THE INVENTION

### First Embodiment

Next, a first embodiment of the present invention will be described with reference to the drawings. In the following description of the drawings of the first embodiment, identical or similar constituents are designated by identical or similar reference numerals.

The first embodiment will be described in the order of (1) an overall schematic configuration, (2) a configuration of the radio base station, (3) transmission power control processing, go (4) an interference countermeasure, (5) an operation of the radio base station, and (6) effects and advantages.

(1) Overall Schematic Configuration

Firstly, an overall schematic configuration of a radio communication system according to the first embodiment will be described.

(1.1) Configuration of Radio Communication System

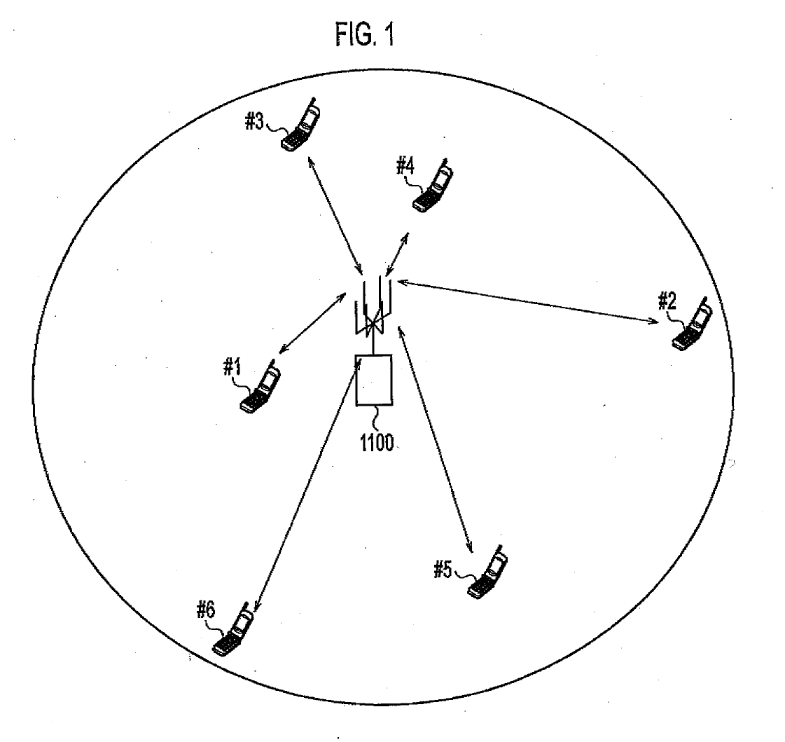

FIG. 1 is an overall schematic configuration diagram of the radio communication system according to the first embodiment. As shown in FIG. 1, the radio communication system according to the first embodiment includes a radio base station 1100 and multiple radio terminals (radio terminals #1 to #6).

In the first embodiment, each of the radio base station 1100 and the radio terminals #1 to #6 has a configuration based on the WiMAX standard (IEEE 802.16e). According to the WiMAX standard, downlink (downward direction) communication and uplink (upward direction) communication are executed in different periods.

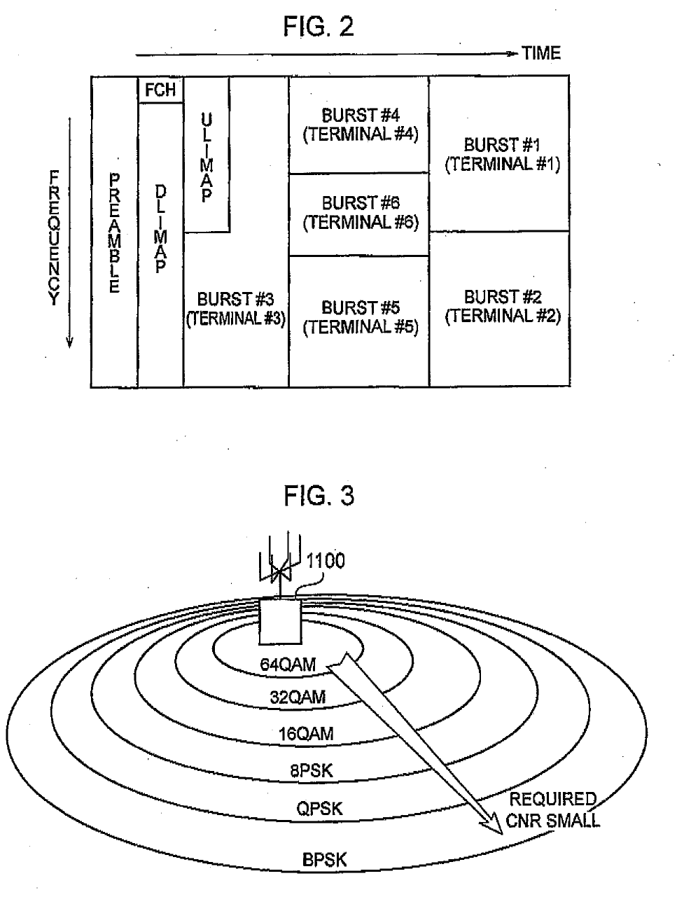

The radio terminals #1 to #6 are located inside a cell formed by the radio base station 1100, and are connected to the radio base station 1100 to perform communication. In the first embodiment, channels (which are called “bursts” in the WiMAX standard) are assigned to the radio terminals #1 to #6, respectively, as shown in FIG. 2.

In FIG. 2, the radio terminal #1 and the radio terminal #2 use different frequencies (subcarriers) on the frequency axis, but perform downlink communication with the radio base station 1100 at the same timing on the time axis.

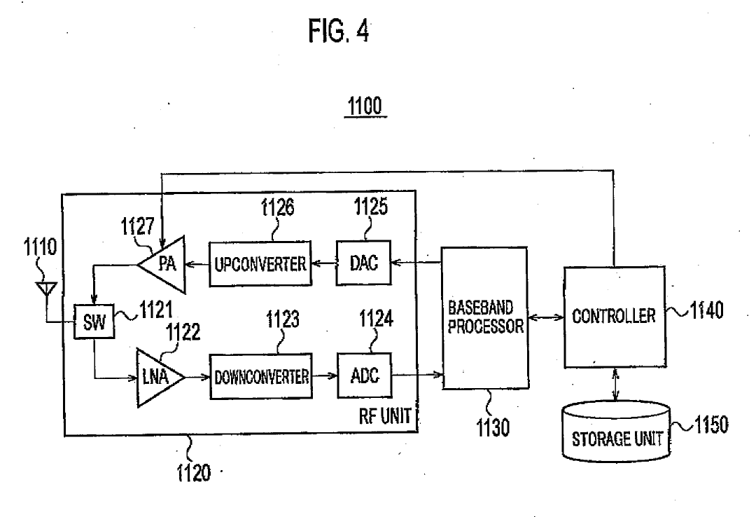

The radio terminals #4 to #6 also perform downlink communication with the radio base station 1100 at the same timing. In this case, a power amplifier 1127 (see FIG. 4) of the radio base station 1100 may come close to saturation at that timing.

(1.2) Outline of Adaptive Modulation

In the WiMAX standard, in order to speed up a communication rate, adaptive modulation is introduced in which a modulation mode and an encoding mode corresponding to reception quality at a radio terminal are selected. In the following, a case of using a carrier-to-noise ratio (CNR) as the reception quality will be described.

The radio terminals #1 to #6 each measure the CNR of a radio signal received from the radio base station 1100, and each notify the radio base station 1100 of the measured CNR. The radio base station 1100 selects a modulation class for each of the radio terminals in accordance with the CNR notified from each of the radio terminals #1 to #6.

The radio terminals #2, #3, and #6 are distant from the radio base station 1100 and located close to a cell edge. The radio terminals #1, #4, and #5 are close to the radio base station 1100 compared to the radio terminals #2, #3, and #6.

In the general adaptive modulation, the transmission power of the radio base station 1100 is set constant for each subcarrier. For this reason, as shown in FIG. 3, the radio terminals #2, #3, and #6 which are located close to the cell edge communicate with the radio base station 1100 in a low-speed modulation class (such as BPSK).

In the following, a case where the radio terminal #1 is executing voice communication in accordance with the VoIP (Voice over Internet Protocol) and is not requesting the radio base station 1100 of a high-speed communication rate will be described. On the other hand, the radio terminal #2 is assumed to be executing data communication such as video streaming and requesting the radio base station 1100 of a high-speed communication rate.

(2) Configuration of Radio Base Station

Next, a configuration of the radio base station 1100 will be described.

(2.1) Overall Schematic Configuration of Radio Base Station

FIG. 4 is a functional block diagram showing an overall schematic configuration of the ratio base station 1100. As shown in FIG. 4, the radio base station 1100 includes an antenna 1110, a RF unit 1120, a baseband processor 1130, a controller 1140, and a storage unit 1150.

The RF unit 1120 performs transmission or reception of radio signals (RF signals) by using the antenna 1110. The RF unit 1120 includes a transmission-reception switching SW (TxRx switch) 1121, a low noise amplifier 1122, a downconverter 1123, an A/D converter 1124, a D/A converter 1125, an upconverter 1126, and a power amplifier 1127.

The transmission-reception switching SW 1121 performs switching between transmission and reception of radio signals. The low noise amplifier 1122 amplifies a radio signal received by the antenna 1110. The downconverter 1123 downconverts the amplified radio signal. The A/D converter 1124 generates a baseband signal by converting the downconverted radio signal into a digital signal. The generated baseband signal is inputted to the baseband processor 1130.

The D/A converter 1125 converts a baseband signal generated by the baseband processor 1130 into an analog signal. The upconverter 1126 upconverts the analog signal outputted from the D/A converter 1125. The power amplifier 1127 amplifies a radio signal obtained by the upconversion.

The baseband processor 1130 demodulates the baseband signal from the baseband signal, and performs error correction decoding, when receiving the signal. The baseband processor 1130 modulates the baseband signal by using a modulation class specified by the controller 1140, and performs error correction encoding, when transmitting the signal.

The controller 1140 controls various functions possessed by the radio base station 1100. The storage unit 1150 stores a variety of information used for the control of the radio base station 1100 and the like. More detailed functional blocks of the controller 1140 and the storage unit 1150 will be described later.

(2.2) Detailed Configurations of Controller and Storage Unit

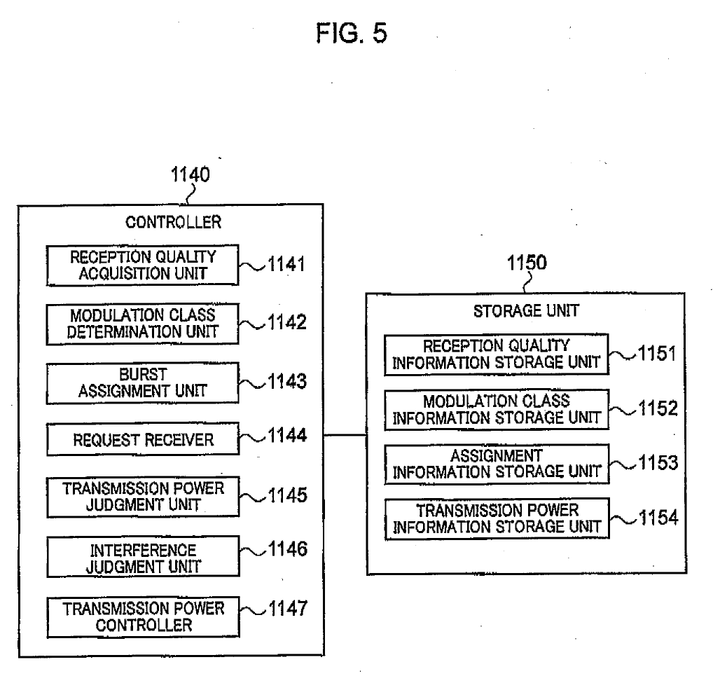

FIG. 5 is a functional block diagram showing detailed configurations of the controller 1140 and the storage unit 1150.

As shown in FIG. 5, the controller 1140 includes a reception quality acquisition unit 1141, a modulation class determination unit 1142, a burst assignment unit 1143, a request receiver 1144, a transmission power judgment unit 1145, an interference judgment unit 1146, and a transmission power controller 1147.

The storage unit 1150 includes a reception quality information storage unit 1151, a modulation class information storage unit 1152, an assignment information storage unit 1153, and a transmission power information storage unit 1154.

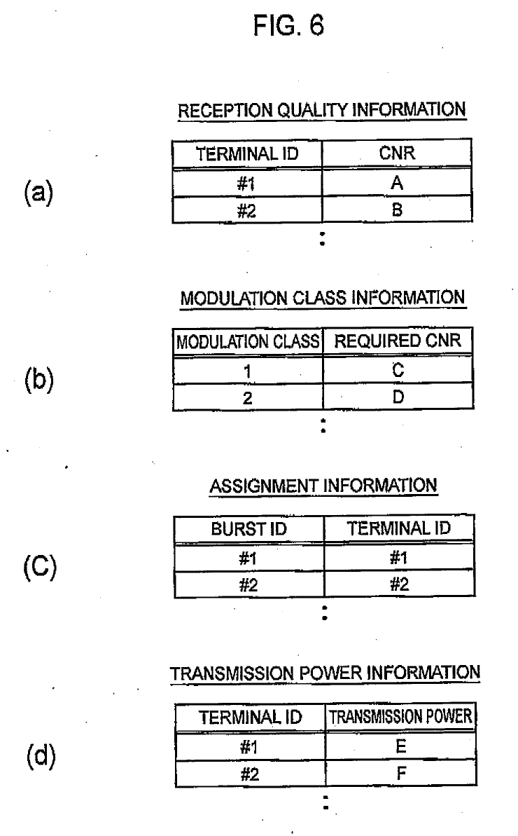

The reception quality acquisition unit 1141 acquires information on the downlink CUR from each of the communicating radio terminals #1 to #6. The acquired reception quality information is stored in the reception quality information storage unit 1151 as shown in FIG. 6(a). The reception quality information storage unit 1151 stores the reception quality information in which each of terminal IDs is associated with the corresponding MR.

The modulation class information storage unit 1152 stores modulation class information in which each of modulation classes is associated with the corresponding CNR required for the modulation class as shown in FIG. 6(b). The modulation class determination unit 1142 refers to the modulation class information storage unit 1152, and determines the modulation class corresponding to the information on the CNR acquired by the reception quality acquisition unit 1141.

Here, even when the radio terminal is configured to receive the radio signal at high reception quality, the modulation class determination unit 1142 assigns a low modulation class to the radio terminal when the radio terminal performs communication at a low speed. This radio terminal can continue communication with the radio base station 1100 even if the transmission power from the radio base station 1100 is reduced.

The burst assignment unit 1143 assigns bursts to the communicating radio terminals #1 to #6, respectively. Results of burst assignment are stored in the assignment information storage unit 1153. The assignment information storage unit 1153 stores the assignment information in which each of burst IDs is associated, with the corresponding terminal ID as shown in FIG. 6(c).

The request receiver 1144 receives a high-speed communication request from the communicating radio terminals #1 to #6, the high-speed communication request being a request for increasing a downlink communication rate (the transmission power of the radio base station 1100).

The transmission power judgment unit 1145 judges whether the power amplifier 1127 is close to saturation when the request receiver 1144 receives the high-speed communication request. Specifically, the transmission power judgment unit 1145 judges whether a sum of the transmission power reaches a threshold at the timing for transmitting the radio signal to the radio terminal transmitting the high-speed communication request.

When the sum of the transmission power reaches the threshold, the transmission power judgment unit 1145 judges whether it is possible to reduce the transmission power for a radio terminal communicating simultaneously with the radio terminal transmitting the high-speed communication request.

The interference judgment unit 1146 judges whether an increase in the transmission power for the radio terminal transmitting the high-power communication request will cause interference with an adjacent cell.

The transmission power controller 1147 controls the transmission power of the radio signals transmitted to the communicating radio terminals #1 to #6. Transmission power values of the radio signals are stored in the transmission power information storage unit 1154. The transmission power information storage unit 1154 stores the transmission power information in which each of the terminal ID is associated with the corresponding transmission power value as shown in FIG. 6(d).

(3) Transmission Power Control Processing

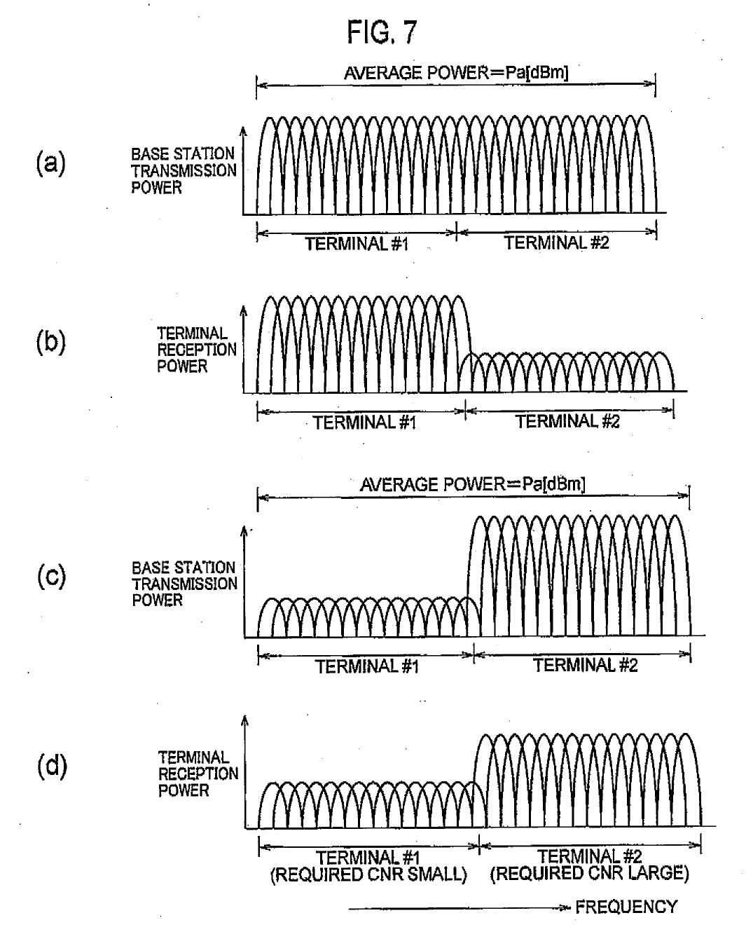

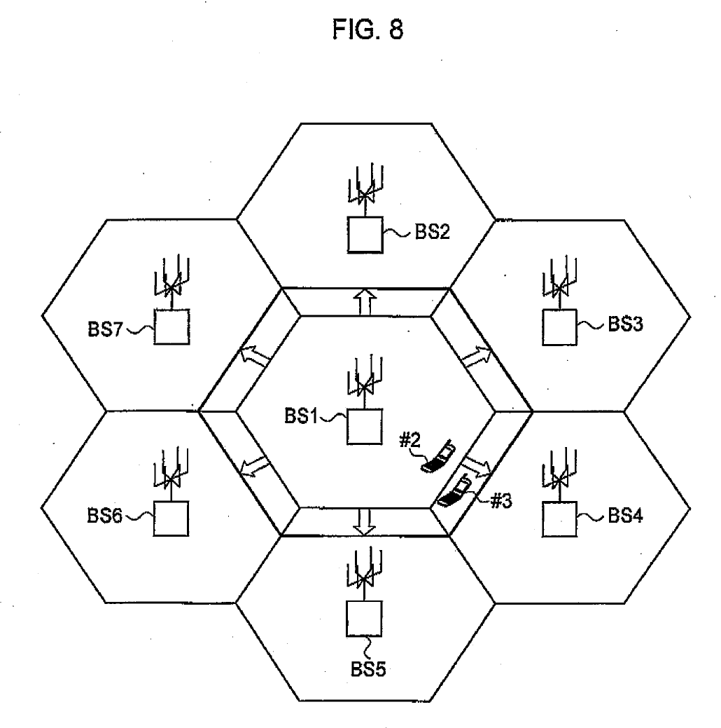

Next, transmission power control processing executed by the radio base station 1100 will be described. FIG. 7 is a view for explaining the transmission power control processing executed by the radio base station 1100.

Here, considered is a case where the radio terminals #1 and #2 establish a positional relationship as shown in FIG. 1 in an open situation without particular obstacles. It is possible to say that a propagation condition of the radio terminal #1 close to the radio base station 1100 is good and that a propagation condition of the radio terminal #2 distant therefrom is poor by contrast.

As shown in FIG. 7(a), the transmission power of each of the subcarriers transmitted by the radio base station 1100 is the same. Here, average power of all the subcarriers is defined as Pa [dBm].

FIG. 7(b) shows reception power of each of the radio terminal #1 and the radio terminal #2. There is a large propagation loss in the radio terminal #2 which is distant from the radio base station 100. For this reason, the reception power of the radio terminal #2 is smaller as compared to the reception power of the radio terminal #1.

As described previously, in the adaptive modulation, the CNR necessary for each modulation class (the required CNR) is fixed, and the radio terminal #1 having the good CNR can communicate in a high-speed modulation mode (such as 64 QAM). On the other hand, the radio terminal #2 having the poor CNR communicates in a low-speed modulation mode (such as the BPSK).

Here, assume that the radio terminal #1 is communicating in the low-speed modulation class (such as QPSK) though the radio terminal #1 can use the high-speed modulation class (such as the 64QAM)—As shown in FIG. 7(c), the radio base station 1100 reduces the transmission power for the radio terminal #1 which does not request the high-speed communication, and increases the transmission power for the radio terminal #2 which requests the high-speed communication.

At this time, the average power of all the subcarriers is Pa [dBm] as similar to FIG. 7(a). Accordingly, linearity of the power amplifier 1127 is maintained. That is, the radio signals to be transmitted to the radio terminal #1 and the radio terminal #2 are not distorted by the power amplifier 1127.

Moreover, although the reception CNR of the radio terminal #1 is reduced, the radio terminal #1 is communicating in the low-speed modulation class (such as the QPSK). Since the required CNR is low, there is no influence on the communication quality.

FIG. 7(d) shows the reception power when the radio terminals #1 and #2 receive the radio signals transmitted at the transmission power shown in FIG. 7(a). Although the CNR of the radio terminal #1 is degraded, there is no influence on the communication quality because the CNR required for the QPSK is low as described previously.

As shown in FIG. 7(d), the CNR is improved in the radio terminal #2. For example, the radio base station 1100 changes the downlink modulation class for the radio terminal #2 from the BPSK to the QPSK. As a result, the radio terminal #2 can communicate in the high-speed modulation class.

(4) Interference Countermeasure

As described above, the radio terminal #2 can communicate in the high-speed modulation class as the radio base station 1100 reduces the transmission power for the radio terminal #1 and increases the transmission power for the radio terminal #2. Nevertheless, the increase in the transmission power for the radio terminal #2 located on the cell edge increases interference with an adjacent cell.

Here, a hexagonal cell configuration as shown in FIG. 8 will be considered. A cell radius is considered to be equivalent to a radius in which communication using the BPSK in FIG. 3 is possible. When increasing the downlink transmission power of the subcarrier assigned to the radio terminal #2, a accessible range of the radio wave is extended as shown in FIG. 8. As a result, the radio signal to be transmitted to the radio terminal #2 constitutes an interference source (noise) for the radio terminal #3 in the adjacent cell.

There are some methods to avoid this interference. Methods of avoiding interference will be described below.

(4.1) Method of Avoiding Interference (Pattern 1)

The radio base station 1100 confirms that the same frequency is not used at the same timing in the adjacent cell prior to increasing the downlink transmission power for the radio terminal #2. The radio base station 1100 increases the downlink transmission power for the radio terminal #2 only if the same frequency is not used at the same timing in the adjacent cell.

(4.2) Method of Avoiding Interference (Pattern 2)

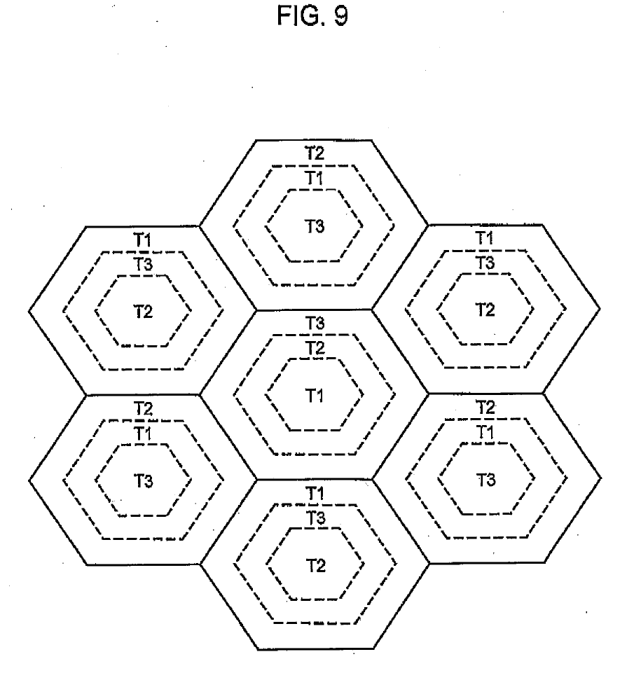

The timing for performing communication is split depending on the position of the terminal inside the cell as shown in FIG. 9. Details of this method is described in UP-A 2003-46437. T1 to T3 shown in FIG. 9 represent transmission timing factors in is one frame period.

It is basically possible to avoid interference in all the adjacent cells around by splitting the timing for performing communication. Actually, restriction of the position and the timing as described above may reduce frequency use efficiency depending on an location state inside the cell (when the terminals are concentrated in one position). Accordingly, it is preferable to operate this method in combination with the above-described method (4.1).

(4.3) Method of Avoiding Interference (Pattern 3)

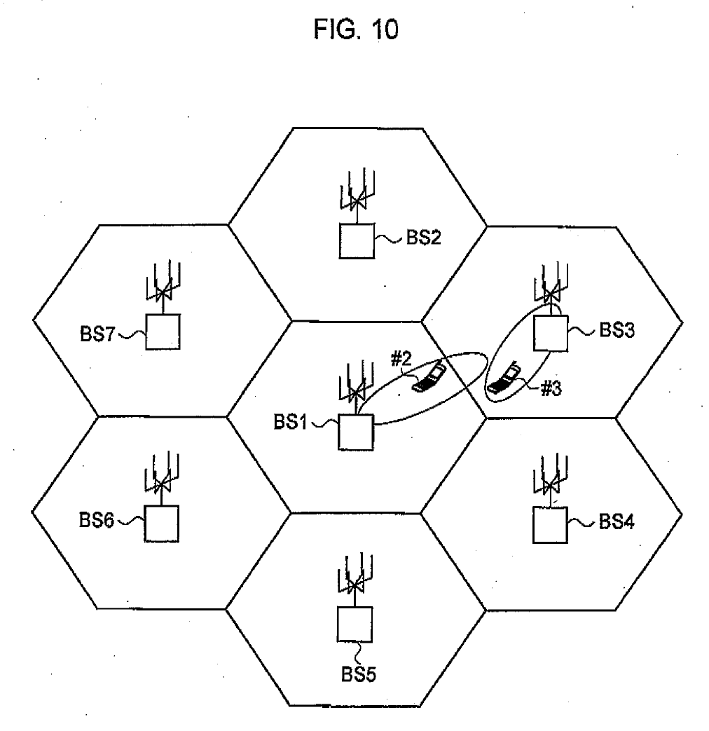

Adaptive array control is an effective method for further improving the frequency use efficiency. In the adaptive array control, the radio base station 1100 orients directivity of the so radio wave in a desired direction as shown in FIG. 10 so as not to be influenced by unwanted radio waves.

By using this method, it is possible to substantially increase frequencies and timing factors usable inside the area unless there is a terminal susceptible to interference, the terminal located in the direction to which the directivity of the radio wave is oriented. Hence it is possible to perform operation at high frequency use efficiency.

(5) Operation of Radio Base Station

Next, the operation of the radio base station 1100 according to the first embodiment will be described. In the following, description will be made in the order of (5.1) an overall operation of the radio base station and (5.2) an interference judgment operation by the radio base station.

(5.1) Overall Operation of Radio Base Station

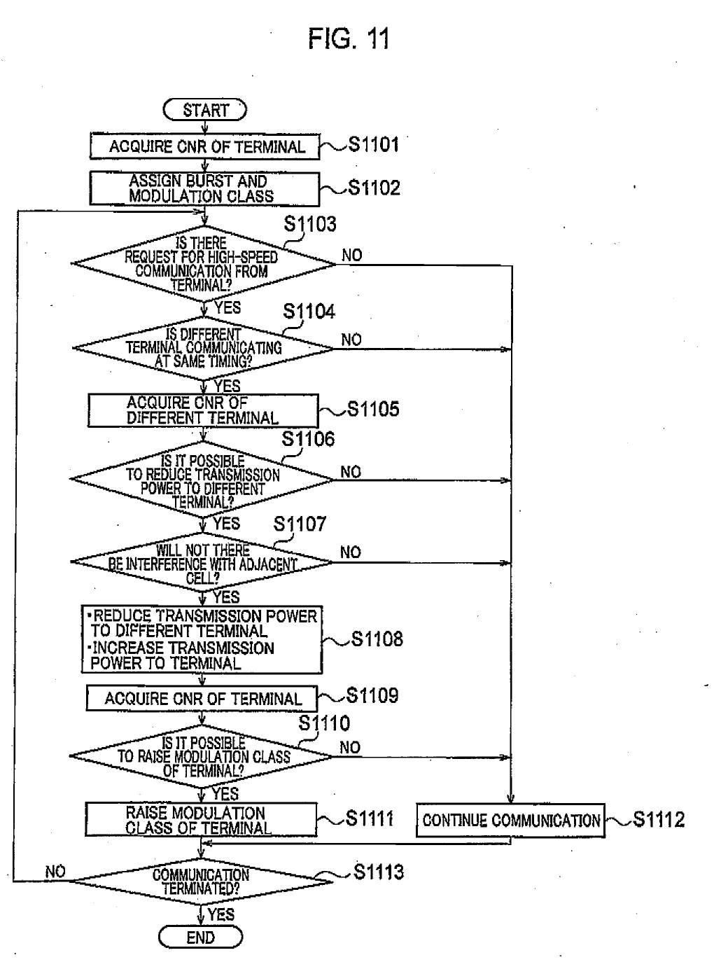

FIG. 11 is a flowchart showing the overall operation of the radio base station 1100.

In step S1101, the radio base station 1100 starts communication with the radio terminal #2 and acquires the CNR of the radio terminal #2.

In step S1102, the radio base station 1100 determines a burst (the frequency and the timing) to be assigned to the radio terminal #2 based on the ONE notified by the radio base station 1100 and on conditions of use of other terminals.

In step S1103, the radio base station 1100 judges whether the communicating radio terminal #2 requests for communication in a higher speed. The processing goes to step S1104 when the radio terminal #2 requests for communication in higher speed. On the other hand, the processing goes to step S1112 when the radio terminal #2 does not request for communication in higher speed. The current state of communication is maintained in step S1112.

In step S1104, the radio base station 1100 judges whether there is another radio terminal executing downlink communication at the same timing as the radio terminal #2. Here, the radio terminal #1 is judged to be executing the downlink communication at the same timing as the radio terminal #2.

Then, when there is the radio terminal executing the downlink communication at the same timing as the radio terminal #2, the radio base station 1100 judges whether the sum of the transmission power at that timing reaches a threshold. The processing goes to step S1105 when the sum of the transmission power reaches the threshold. On the other hand, the processing goes to step S1112 when the sum of the transmission power does not reach the threshold.

In step S1105, the radio base station 1100 acquires the CNR of the radio terminal #1.

In step S1106, the radio base station 1100 judges whether it is possible to reduce the transmission power for the radio terminal #1. Specifically, the radio base station 1100 compares the CNR of the radio terminal #1 acquired in step S1105 with the sa CNR required for the modulation class applied to the radio terminal #1. The radio base station 1100 judges that it is possible to reduce the transmission power for the radio terminal #1 only if the CNR of the radio terminal #1 acquired in step S1105 is greater than the CNR required for the modulation class applied to the radio terminal #1.

In step S1107, the radio base station 1100 judges whether the increase in the transmission power for the radio terminal #1 causes the interference with the adjacent cell. The processing goes to step S1108 when it is judged that the increase in the transmission power for the radio terminal #1 will not cause the interference with the adjacent cell. On the other hand, the processing goes to step S1112 when it is judged that the increase in the transmission power for the radio terminal #1 causes the interference with the adjacent cell.

In step S1108, the radio base station 1100 reduces the transmission power for the radio terminal #1, and increases the transmission power for the radio terminal #2.

In step S1109, the radio base station 1100 acquires the CNR of the radio terminal #2 again. Specifically, the radio base station 1100 judges whether the CNR of the radio terminal #2 is improved by increasing the transmission power for the radio terminal #2.

In step S1110, the radio base station 1100 judges whether it is possible to raise the downlink modulation class of the radio terminal #2. The processing goes to step S1112 when the CNR is still short of the required CNR even after increasing the transmission power for the radio terminal #2. On the other hand, when it is possible to raise the downlink modulation class of the radio terminal #2, the communication is performed in the modulation class with the maximum transmission rate that meets the required CNR.

In step S1113, the radio base station 1100 judges whether to terminate the communication with the radio terminal #2. The processing is terminated when the communication with the radio terminal #2 is terminated. The processing returns to step S1103 when the communication with the radio terminal #2 is not terminated.

(5.2) Interference Judgment Operation by Radio Base Station

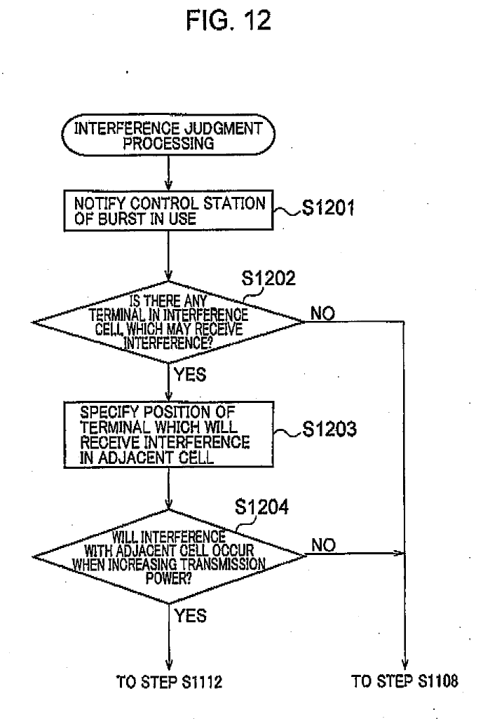

FIG. 12 is a flowchart showing the interference judgment operation by the radio base station 1100.

In step S1201, the radio base station 1100 notifies a control station (a higher-level device of the radio base station 1100) of the burst (the frequency and the timing) assigned to the radio terminal #2.

In step S1202, upon receipt of the notice from the radio base station 1100, the control station judges whether there is the radio terminal #3 in the adjacent cell which uses the same frequency at the same timing as the radio terminal #2.

In step S1203, the control station request a radio base station communicating with the radio terminal #3 to acquire so positional information of the radio terminal #3. The positional information of the radio terminal #3 is acquired based on positional information using GPS, the transmission power of the radio base station 1100, the reception power of the radio terminal #3, or the like, for example. The acquired positional information is notified to the radio base station 1100.

In step S1204, the radio base station 1100 judges whether the increase in the downlink transmission power for the radio terminal #2 causes interference with the radio terminal #3 based on the downlink transmission power of the radio terminal #2 and the positional information acquired in step S1203.

(6) Effects and Advantages

As described above, according to the first embodiment, the is radio base station 1100 reduces the transmission power of the radio signal to be transmitted to the radio terminal #1, and increases the transmission power of the radio signal to be transmitted to the radio terminal #2, when the radio base station 1100 judges that the sum of the transmission power at timing of transmitting the radio signals to the radio terminals #1 and #2 reaches the threshold and that it is possible to reduce the transmission power of the radio signal to be transmitted to the radio terminal #1.

Therefore, even when the amplifier in the transmitter of the radio base station 1100 is close to saturation, it is still possible to increase the transmission power of the radio signal to be transmitted to the radio terminal having low reception quality (the radio terminal #2).

Moreover, according to the first embodiment, the radio base station 1100 acquires the CNR of the radio signals received by the radio terminals #1 and #2, and determines the modulation classes to be applied to the radio signals to be transmitted to the radio terminals #1 and #2, respectively, in accordance with the acquired reception quality.

Since the CNR of the radio terminal #2 is improved by increasing the transmission power of the radio signal to be transmitted to the radio terminal #2, it is possible to raise the modulation class to be applied to the radio signal to be transmitted to the radio terminal #2. As a result, the radio terminal #2 can execute an application such as video streaming, which requires a high-speed communication rate.

According to the first embodiment, the radio base station 1100 judges that it is possible to reduce the transmission power of the radio signal to be transmitted to the radio terminal #1 when the reception quality of the radio signal received by the radio terminal #1 is higher than the CNR required for the modulation class applied to the radio signal to be transmitted to the radio terminal #1.

Specifically, deterioration in the communication quality of the radio terminal #1 is avoided by reducing the transmission power for the radio terminal #1 only when the CNR of the radio terminal #1 is equal to or higher than a necessary level.

Moreover, according to the first embodiment, the radio base station 1100 increases the transmission power of the radio signal to be transmitted to the radio terminal #2 when it is judged that the radio signal to be transmitted to the radio terminal #2 will not interfere with the radio terminal #3 located inside the adjacent cell.

Therefore, even if the transmission power of the radio signal to be transmitted to the radio terminal #2 is increased, it is still possible to prevent the radio signal from interfering with the radio terminal #3 located inside the adjacent cell.

### Second Embodiment

Next, a second embodiment of the present invention will be described with reference to the drawings. In the following description of the drawings of the second embodiment, identical or similar constituents are designated by identical or similar is reference numerals.

The second embodiment will be described in the order of (1) an overall schematic configuration, (2) a configuration of the radio base station, (3) transmission power control processing, (4) an interference countermeasure, (5) an operation of the radio base station, and (6) effects and advantages.

(1) Overall Schematic Configuration

Firstly, an overall schematic configuration of a radio communication system according to the second embodiment will be described.

(1.1) Configuration of Radio Communication System

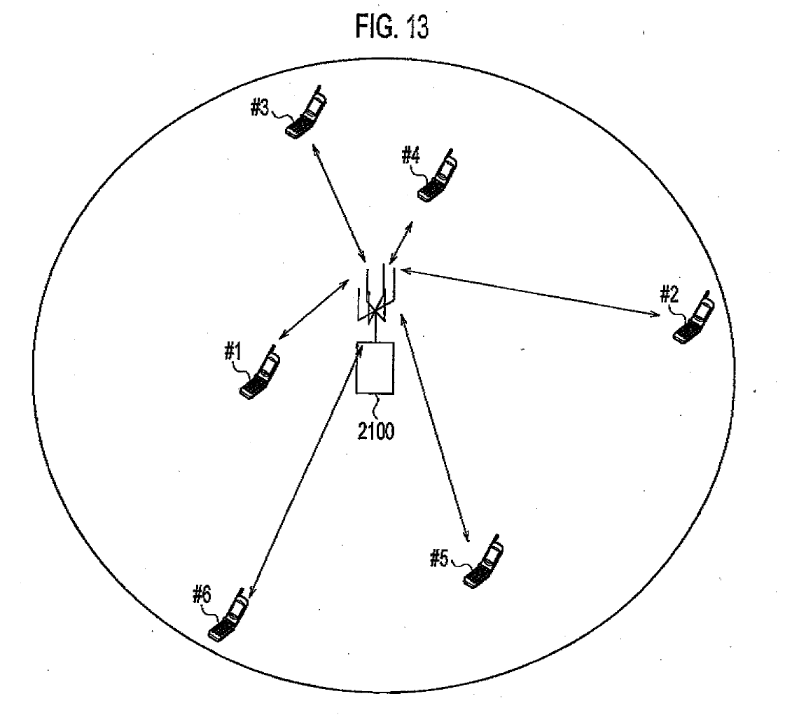

FIG. 13 is an overall schematic configuration diagram of the radio communication system according to the second embodiment. As shown in FIG. 13, the radio communication system according to the second embodiment includes a radio base station 2100 and multiple radio terminals (radio terminals #1 to #6).

Each of the radio base station 2100 and the radio terminals #1 to #6 has a configuration based on the WiMAX standard (IEEE 802.16e). According to the WiMAX standard, the downlink (downward direction) communication and the uplink (upward direction) communication are executed in different periods.

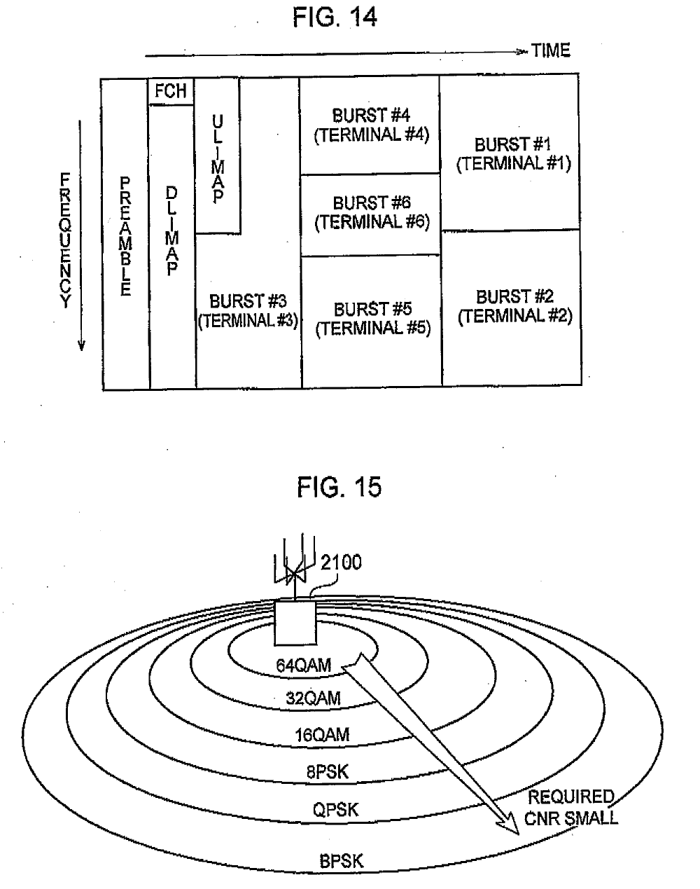

The radio terminals #1 to #6 are located inside a cell formed by the radio base station 2100, and are connected to the radio base station 2100 to perform communication. In the second embodiment, channels (which are called the “bursts” in the WiMAX standard) are assigned to the radio terminals #1 to #6, respectively, as shown in FIG. 14.

In FIG. 14, the radio terminal #1 and the radio terminal #2 use different frequencies (subcarriers) on the frequency axis, 2a but perform downlink communication with the radio base station 2100 at the same timing on the time axis.

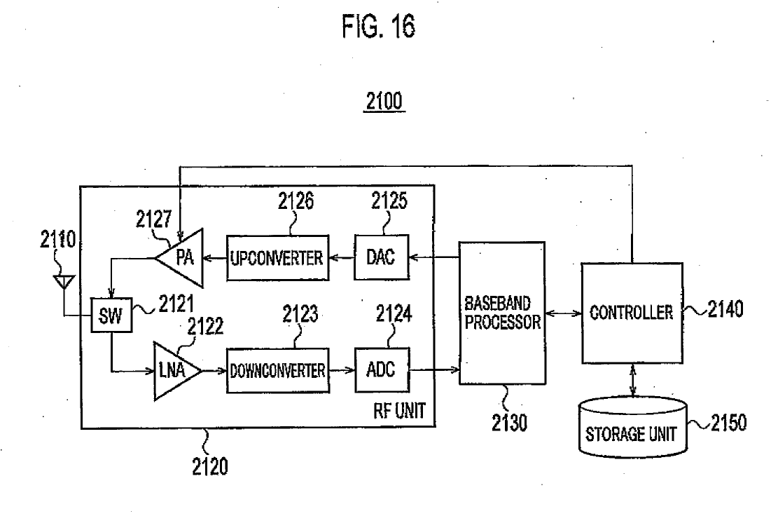

The radio terminals #4 to #6 also perform downlink communication with the radio base station 2100 at the same timing. In this case, a power amplifier 2127 (see FIG. 16) of the radio base station 2100 may come close to saturation at that timing.

(1.2) Outline of Adaptive Modulation

In the WiMAX standard, in order to speed up a communication rate, adaptive modulation is introduced in which a modulation mode and an encoding mode corresponding to reception quality at a radio terminal are selected. In the following, a case of using the carrier-to-noise ratio (CNR) (hereinafter simply referred to as the “CNR”) as the reception quality will be described.

The radio terminals #1 to #6 each measure the CNR of a radio signal received from the radio base station 2100, and each notify the radio base station 2100 of the measured CNR. The radio base station 2100 selects a modulation class for each of the radio terminals in accordance with the CNR notified from each of the radio terminals #1 to #6.

The radio terminals #2, #3, and #6 are distant from the radio base station 2100 and located close to a cell edge. The radio terminals #1, #4, and #5 are close to the radio base station 2100 compared to the radio terminals #2, #3, and #6.

In the general adaptive modulation, the transmission power of the radio base station 2100 is set constant for each subcarrier.

For this reason, as shown in FIG. 15, the radio terminals #2, #3, and #6 which are located close to the cell edge communicate with the radio base station 2100 in a low-speed modulation class (such as BPSK).

In the following, a case where the radio terminal #1 is executing voice communication in accordance with the VoIP (Voice over Internet Protocol) and is not requesting the radio base station 2100 of a high-speed communication rate will be described. On the other hand, the radio terminal #2 is assumed to be executing sa data communication such as video streaming and requesting the radio base station 2100 of a high-speed communication rate.

(2) Configuration of Radio Base Station

Next, a configuration of the radio base station 2100 will be described.

(2.1) Overall Schematic Configuration of Radio Base Station

FIG. 16 is a functional block diagram showing an overall schematic configuration of the ratio base station 2100. As shown in FIG. 16, the radio base station 2100 includes an antenna 2110, a RF unit 2120, a baseband processor 2130, a controller 2140, and a storage unit 2150.

The RE unit 2120 performs transmission or reception of radio signals (RF signals) by using the antenna 2110. The RE unit 2120 includes a transmission-reception switching switch (TxRx switch) 2121, a low noise amplifier 2122, a downconverter 2123, an A/D converter 2124, a D/A converter 2125, an upconverter 2126, and a power amplifier 2127. The transmission-reception switching switch (TxRx switch) 2121 performs switching between transmission and reception. The low noise amplifier 2122 amplifies a radio signal received by the antenna 2110. The downconverter 2123 downconverts the amplified radio signal. The A/D converter 2124 generates, a baseband signal by converting the downconverted radio signal into a digital signal. The generated baseband signal is inputted to the baseband processor 2130.

The D/A converter 2125 converts a baseband signal generated by the baseband processor 2130 into an analog signal. The sa upconverter 2126 upconverts the analog signal outputted from the D/A converter 2125. The power amplifier 2127 amplifies a radio signal obtained by the upconversion.

The baseband processor 2130 demodulates the baseband signal from the baseband signal, and performs error correction decoding, when receiving the signal. The baseband processor 2130 modulates the baseband signal by using a modulation class instructed by the controller 2140, and performs error correction encoding, when transmitting the signal.

The controller 2140 controls various functions possessed by the radio base station 2100. The storage unit 2150 stores a variety of information used for the control of the radio base station 2100 and the like. More detailed functional blocks of is the controller 2140 and the storage unit 2150 will be described later.

(2.2) Detailed Configurations of Controller and Storage Unit

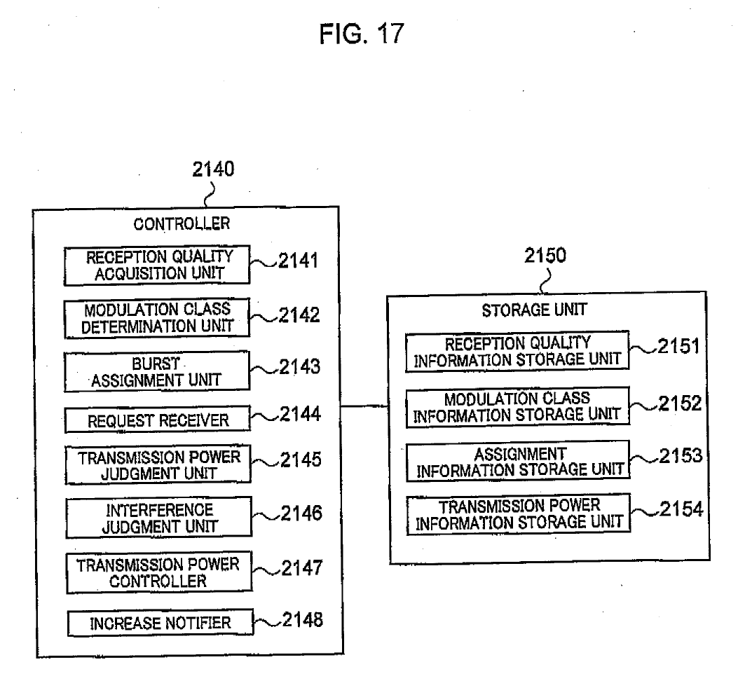

FIG. 17 is a functional block diagram showing detailed configurations of the controller 2140 and the storage unit 2150

As shown in FIG. 17, the controller 2140 includes a reception quality acquisition unit 2141, a modulation class determination unit 2142, a burst assignment unit 2143, a request receiver 2144, a transmission power judgment unit 2145, an interference judgment unit 2146, a transmission power controller 2147, and an increase notifier 2148.

The storage unit 2150 includes a reception quality information storage unit 2151, a modulation class information storage unit 2152, an assignment information storage unit 2153, and a transmission power information storage unit 2154.

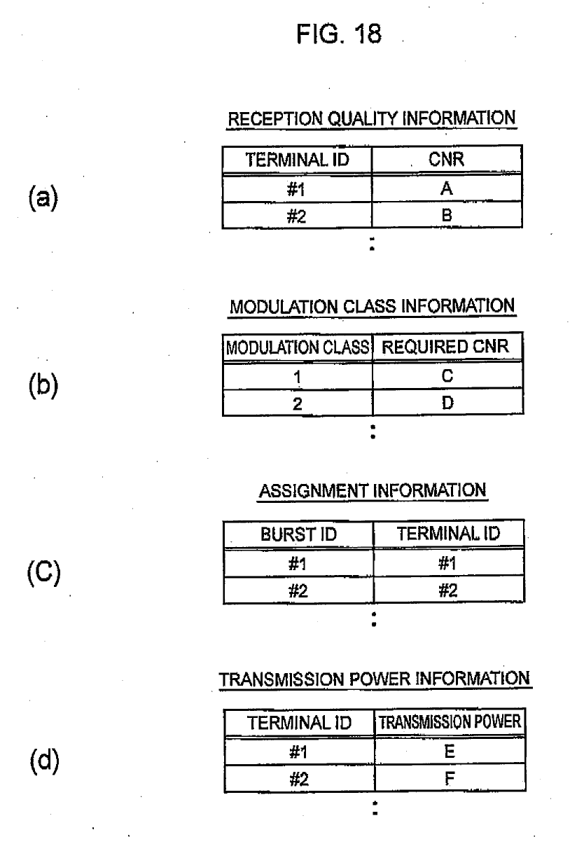

The reception quality acquisition unit 2141 acquires information on the downlink CNR from each of the communicating radio terminals #1 to #6. The acquired reception quality information is stored in the reception quality information storage unit 2151 as shown in FIG. 18(a). The reception quality information storage unit 2151 stores the reception quality information in which each of terminal IDs is associated with the corresponding CNR.

The modulation class information storage unit 2152 stores modulation class information in which each of modulation classes is associated with the corresponding CNR required for the modulation class as shown in FIG. 18(b). The modulation class determination unit 2142 refers to the modulation class information storage unit 2152, and determines the modulation class corresponding to the information on the CNR acquired by the reception quality acquisition unit 2141.

Here, even when the radio terminal is configured to receive the radio signal at high reception quality, the modulation class determination unit 2142 assigns a low modulation class to the radio terminal when the radio terminal performs communication at a low speed. This radio terminal can continue communication with the radio base station 2100 even if the transmission power from the radio base station 2100 is reduced.

The burst assignment unit 2143 assigns bursts to the communicating radio terminals #1 to #6, respectively. Results of burst assignment are stored in the assignment information storage unit 2153. The assignment information storage unit 2153 stores the assignment information in which each of burst IDs is associated with the corresponding terminal ID as shown in FIG. 18(c).

The request receiver 2144 receives a transmission power reduction request (including notification notifying that it is possible to reduce a communication rate) and a high-speed communication request from the communicating radio terminals #1 to #6. The transmission power reduction request is a request for reducing a downlink communication rate (the transmission power of the radio base station 2100). The high-speed communication request is a request for increasing the downlink communication rate (for example, a request based on notification by the increase notifier 2148 notifying that it is possible to increase the transmission power, which is described later).

The transmission power judgment unit 2145 judges whether the power amplifier 2127 is saturated when the request receiver 2144 receives the transmission power reduction request. Specifically, the transmission power judgment unit 2145 judges whether a sum of the transmission power reaches a threshold at the timing for transmitting the radio signal to the radio terminal (first radio communication terminal) transmitting the transmission power reduction request (the transmission power judgment unit 2145 acts as a threshold judgment unit in this case).

Here, when the request receiver 2144 receives the transmission power reduction request, the transmission power judgment unit 2145 judges that it is possible to reduce the transmission power of the radio signal to be transmitted to the radio terminal which receives the request (the transmission power judgment unit 2145 acts as a reduction judgment unit in this case).

Meanwhile, the transmission power judgment unit 2145 executes judgment processing which is different from the above-described judgment processing. To be more precise, the transmission power judgment unit 2145 judges whether the downlink CNR in any of the radio terminals #1 to #6 acquired by the reception quality acquisition unit 2141 is higher than the CNR required for the modulation class applied to the radio signal to be transmitted to the radio terminal, and judges that it is possible to reduce the transmission power of the radio signal to be transmitted to the radio terminal when the downlink CNR is judged higher as a result of the judgment. Then, based on this judgment, transmission power judgment unit 2145 judges whether the power amplifier 2127 is saturated.

When the power amplifier. 2127 is judged to be saturated as a result of this judgment, that is, when the sum value of the transmission power is judged to have reached the threshold, the transmission power judgment unit 2145 judges whether it is possible to increase the transmission power relative to a different radio terminal (a second radio communication terminal) performing communication simultaneously with the radio terminal subject to reduction of the transmission power (the transmission so power judgment unit 2145 acts as an increase judgment unit in this case). Specifically, the transmission power judgment unit 2145 compares the CNR notified from the different, radio terminal with the CNR required for the modulation class applied to the different radio terminal. The radio base station 2100 judges that it is possible to increase the transmission power for the different radio terminal if the CNR notified from the different radio terminal falls below the CNR required, for the modulation class applied to the different radio terminal.

The interference judgment unit 2146 judges whether an increase in the transmission power for the second radio terminal will cause interference with an adjacent cell, when the transmission power judgment unit 2145 judges that it is possible to increase the transmission power for the second radio terminal.

The transmission power controller 2147 controls the transmission power of the radio signals to be transmitted to the communicating radio terminals #1 to #6. Transmission power values of the radio signals are stored in the transmission power information storage unit 2154. The transmission power information storage unit 2154 stores the transmission power information in which each of the terminal ID is associated with the corresponding transmission power value as shown in FIG. 18(d).

When the transmission power judgment unit 2145 (when acting as the increase judgment unit) judges that it is possible to increase the transmission power of the radio signal to be transmitted to the different radio terminal, the increase notifier 2148 notifies the different radio terminal of this fact. Here, if the different radio terminal receiving this notice desires the increase in the transmission power of the radio signal, the different radio terminal, issues a request for the increase in the transmission power in response to this notice.

(3) Transmission Power Control Processing

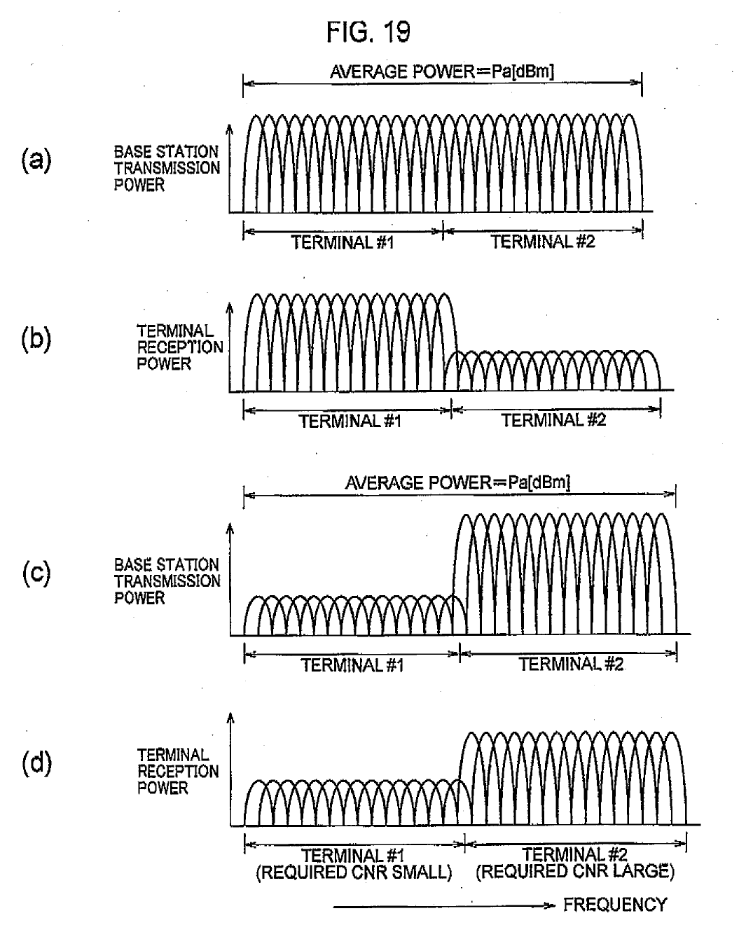

Next, transmission power control processing executed by the radio base station 2100 will be described. FIG. 19 is a view for explaining the transmission power control processing executed by the radio base station 2100.

Here, considered is a case where the radio terminals #1 and #2 establish a positional relationship as shown in FIG. 13 in an open situation without particular obstacles. It is possible to say that a propagation condition of the radio terminal #1 (the first radio terminal) close to the radio base station 2100 is good and that a propagation condition of the radio terminal #2 (the second radio terminal) distant therefrom is poor by contrast.

As shown in FIG. 19(a), the transmission power of each of RO the subcarriers transmitted by the radio base station 2100 is the same. Here, average power of all the subcarriers is defined as Pa [dBm].

FIG. 19(b) shows reception power of each of the radio terminal #1 and the radio terminal #2. There is a large propagation loss in the radio terminal #2 which is distant from the radio base station 2100. For this reason, the reception power of the radio terminal #2 is smaller as compared to the reception power of the radio terminal #1.

As described previously, in the adaptive modulation, the CNR necessary for each modulation class (the required CNR) is fixed, and the radio terminal #1 having the good CNR can communicate in a high-speed modulation mode (such as 64QAM). On the other hand, a the radio terminal #2 having the poor CNR communicates in a low-speed modulation mode (such as the BPSK).

Here, assume that the radio terminal #1 is communicating in the low-speed modulation class (such as the QPSK) though the radio terminal #1 can use the high-speed modulation class (such as the 64QAM). To be more precise, it is assumed that the radio terminal #1 is executing communication whose connection status and quality properly can be maintained in spite of the low-speed communication rate, such as communication in accordance with the VoIP (Voice over Internet Protocol).

In this case, the radio base station 2100 reduces the transmission power for the radio terminal #1 which does not request high-speed communication, and increases the transmission power for the terminal #2 which requests high-speed communication as shown in FIG. 19(c).

At this time, the average power of all the subcarriers is Pa [dBm] as similar to FIG. 19(a). Accordingly, linearity of the power amplifier 2127 is maintained. That is, the radio signals to be transmitted to the radio terminal #1 and the radio terminal #2 are not distorted by the power amplifier 2127.

Moreover, although the reception CNR of the radio terminal #1 is reduced, the radio terminal #1 can communicate properly at the low-speed communication rate. Accordingly, the change to the low-speed modulation class (such as the QPSK) due to reduction in the reception CNR does not affect the communication quality.

FIG. 19(d) shows the reception power when the radio terminals #1 and #2 receive the radio signals transmitted at the transmission power shown in FIG. 19(a). Although the CNR of the radio terminal #1 is degraded, there is no influence on the communication quality because the CNR required for the QPSK is low as described previously.

As shown in FIG. 19(d), the CNR is improved in the radio terminal #2. For example, the radio base station 2100 changes the downlink modulation class for the radio terminal #2 from the BPSK to the QPSK. As a result, the radio terminal #2 can change communication from the low-modulation class to the high-speed modulation class.

(4) Interference Countermeasure

As described above, the radio terminal #2 can communicate in the high-speed modulation class as the radio base station 2100 reduces the transmission power for the radio terminal #1 and increases the transmission power for the radio terminal #2. Nevertheless, the increase in the transmission power for the radio terminal #2 located on the cell edge increases interference with an adjacent cell.

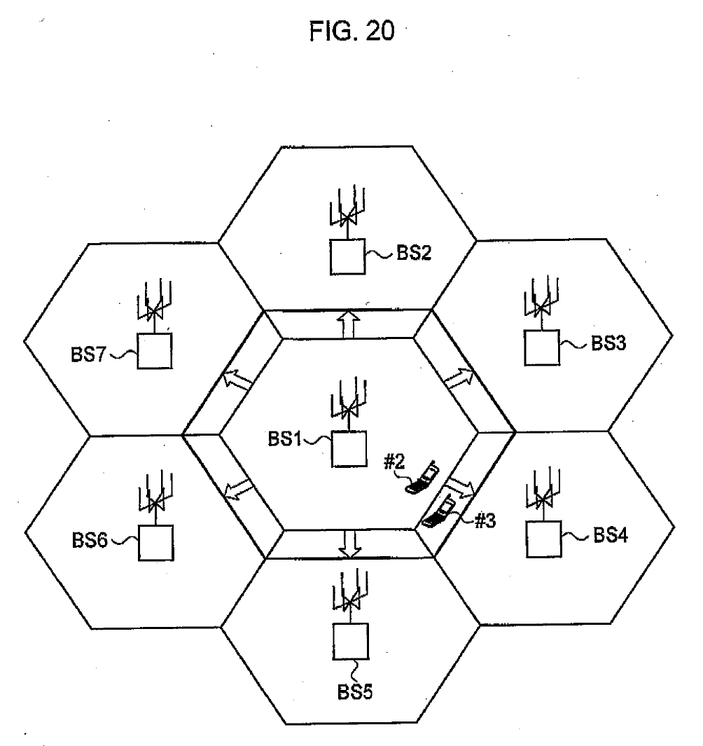

Here, a hexagonal cell configuration as shown in FIG. 20 will be considered. A cell radius is considered to be equivalent to a radius in which communication using the BPSK in FIG. 15 is possible. When increasing the downlink transmission power of the subcarrier assigned to the radio terminal #2, a accessible range of the radio wave is extended as shown in FIG. 20. As a result, the radio signal to be transmitted to the radio terminal #2 a constitutes an interference source (noise) for the radio terminal #3 in the adjacent cell.

There are some methods to avoid this interference. Methods of avoiding interference will be described below.

(4.1) Method of Avoiding Interference (Pattern 1)

The radio base station 2100 confirms that the same frequency is not used at the same timing in the adjacent cell prior to increasing the downlink transmission power for the radio terminal #2. The radio base station 2100 increases the downlink transmission power for the radio terminal #2 only if the same frequency is not used at the same timing in the adjacent cell.

(4.2) Method of Avoiding Interference (Pattern 2)

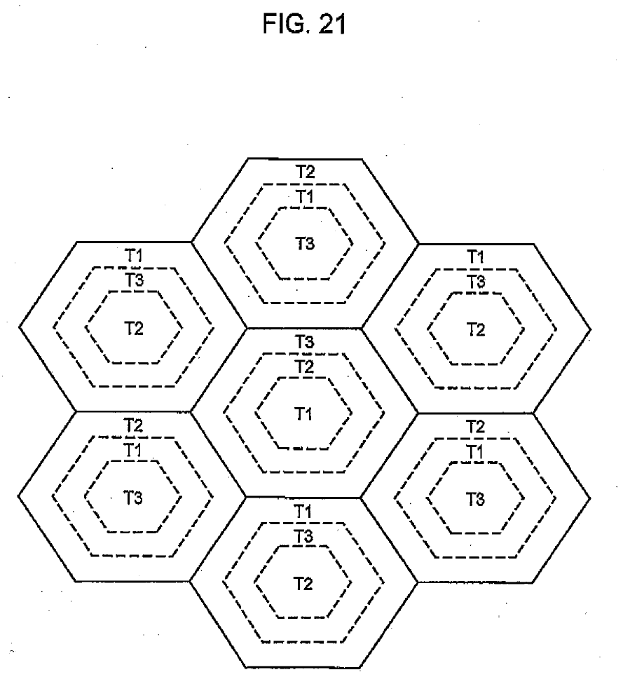

The timing for performing communication is split depending on the position of the terminal inside the cell as shown in FIG. 21. Details of this method is described in JP-A 2003-46437. T1 to T3 shown in FIG. 21 represent the transmission timing factors in one frame period.

It is basically possible to avoid interference in all the adjacent cells around by splitting the timing for performing communication. Actually, restriction of the position and the timing as described above may reduce frequency use efficiency depending on an location state inside the cell (when the terminals are concentrated in one position). Accordingly, it is preferable to operate this method in combination with the above-described method (4.1).

(4.3) Method of Avoiding Interference (Pattern 3).

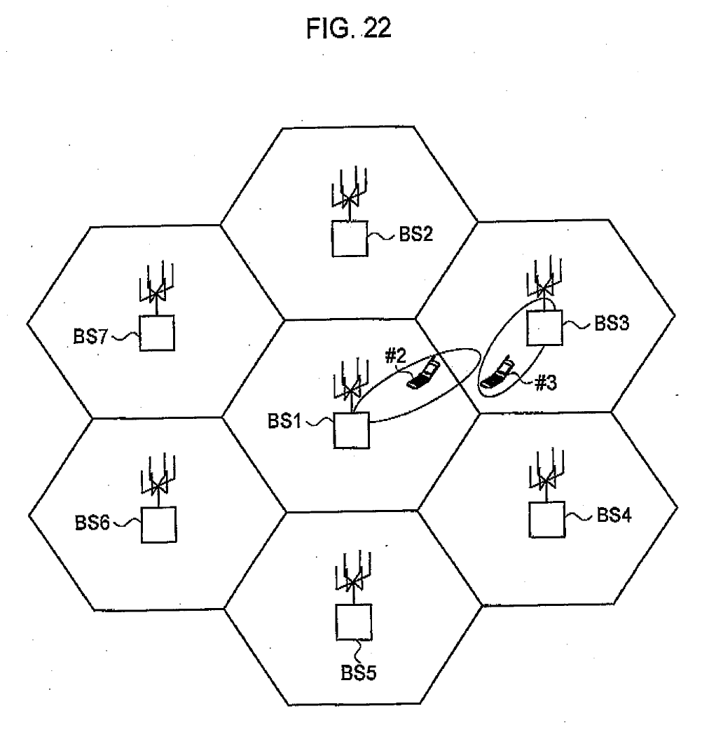

Adaptive array control is an effective method for further improving the frequency use efficiency. In the adaptive array control, the radio base station 2100 orients the directivity of the radio wave in a desired direction as shown in FIG. 22 so as not to be influenced by unwanted radio waves.

By using this method, it is possible to substantially increase frequencies and timing factors usable inside the area unless there is a terminal susceptible to interference, the is terminal located in the direction to which the directivity of the radio wave is oriented. Hence it is possible to perform operation at high frequency use efficiency.

(5) Operation of Radio Base Station

Next, the operation of the radio base station 2100 according to the second embodiment will be described. In the following, description will be made in the order of (5.1) an overall operation of the radio base station and (5.2) an interference judgment operation by the radio base station.

(5.1) Overall Operation of Radio Base Station

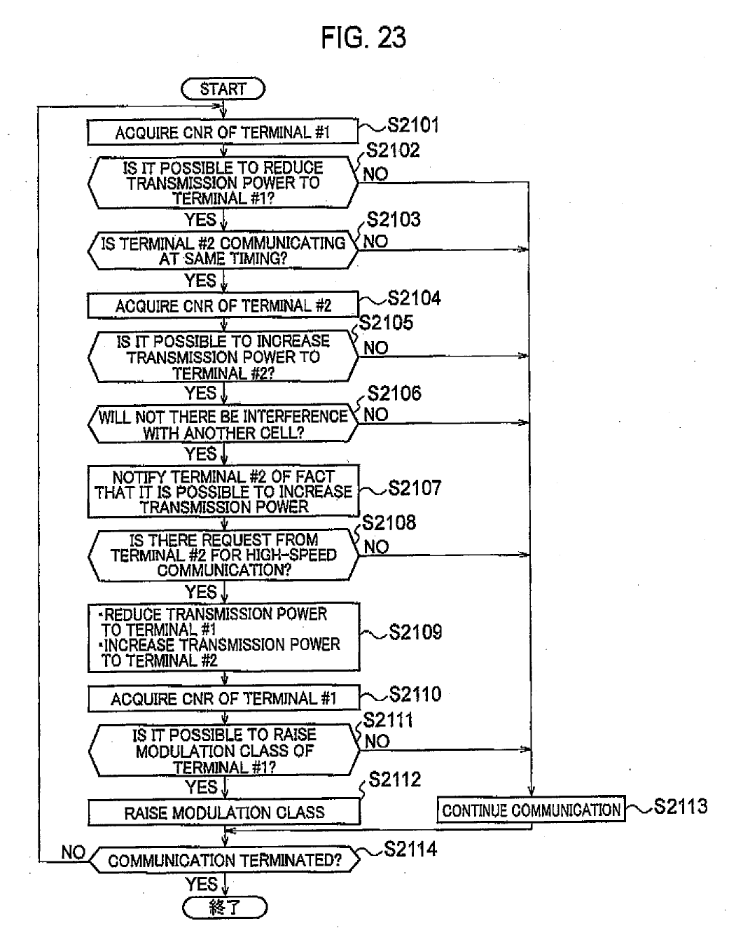

FIG. 23 is a flowchart showing the overall operation of the radio base station 2100.

In step S2101, the radio base station 2100 starts communication with the radio terminal #1 and acquires the CNR of the radio terminal #1. Then, the radio base station 2100 determines the burst (the frequency and the timing) to be assigned to the radio terminal #1 based CM the acquired CNR of the radio terminal #1 and conditions of use of other terminals.

In step S2102, the radio base station 2100 causes the transmission power judgment unit 2145 to judge whether it is possible to reduce the transmission power for the radio terminal #1. This judgment is made either by judging whether the transmission power reduction request is received from the radio terminal #1, or by judging whether the downlink CNR of the radio terminal #1 acquired by the reception quality acquisition unit 2141 is higher than the CNR required for the modulation class applied to the radio signal to be transmitted to the radio terminal. To be more precise, if it is judged that the transmission power reduction request is received from the radio terminal #1, or if it is judged that the downlink CNR of the radio terminal #1 acquired by the reception quality acquisition unit 2141 is higher than the CNR required for the modulation class applied to the radio signal to be transmitted to the radio terminal, then the judgment is made that it is possible to reduce the transmission power for the radio terminal #1.

As a result of this judgment, the processing goes to step S2103 when it is judgment to be possible to reduce the transmission power for the radio terminal #1. On the other hand, the processing goes to step S2113 when it is judged to be not possible to reduce the transmission power for the radio terminal #1. The current state of communication is maintained in step S2113.

In step S2103, the radio base station 2100 judges whether there is another radio terminal (the radio terminal #2) executing downlink communication at the same timing as the radio terminal #1. Here, the radio terminal #1 is judged to be executing the downlink communication at the same timing as the radio terminal #2.

Then, when there is the radio terminal (the radio terminal #2) executing the downlink communication at the same timing as the radio terminal #1, the radio base station 2100 judges whether the sum of the transmission power at that timing reaches a threshold. The processing goes to step S2104 when the sum of the transmission power reaches the threshold. On the other hand, the processing goes to step S2113 when the sum of the transmission power does not reach the threshold.

In step S2104, the radio base station 2100 acquires the CNR of the radio terminal #2.

In step S2105, the radio base station 2100 judges whether it is possible to increase the transmission power for the radio terminal #2. Specifically, the radio base station 2100 compares the CNR of the radio terminal #2 acquired in step S2104 with the required CNR (a value calculated based on the downlink communication quality) of the modulation class to be applied to the radio terminal #2. The radio base station 2100 judges that it is possible to increase the transmission power for the radio terminal #2 when the CNR of the radio terminal #2 acquired in step S2104 falls below the CNR required for the modulation class applied to the radio terminal #2. As a result of the judgment, the processing goes to step S2106 when it is judged that it is possible to increase the transmission power for the radio terminal #2. On the other hand, the processing goes to step S2113 when it is judged that it is not possible to increase the transmission power for the radio terminal #2.

In step S2106, the radio base station 2100 judges whether the increase in the transmission power for the radio terminal #2 will cause the interference with the adjacent cell. The processing goes to step S2107 when it is judged that the increase in the transmission power for the radio terminal 4+2 will not cause the interference with the adjacent cell. On the other hand, the processing goes to step S2113 when it is judged that the increase in the transmission power for the radio terminal #2 will cause the interference with the adjacent cell.

In step S2107, the radio base station 2100 notifies the radio terminal #2 of the fact that it is possible to increase the transmission power. This notification is executed by the increase notifier 2146. Upon receipt of the notice, the radio terminal #2 judges whether the terminal itself requires high-speed communication (communication in a high-speed modulation class) based on the notice. Specifically, if the radio terminal #2 intends to download a large-volume file or high-resolution image data in the current communication or future communication, for example, then it is preferable to perform the communication in a modulation class which is as fast as possible. Accordingly, the radio terminal #2 judges that the high-speed communication so is necessary when the terminal itself intends to download a large-volume file or high-resolution image data. If it is judged that the high-speed communication is necessary as a result of the judgment, the radio terminal #2 issues a request for the high-speed communication to the radio base station 2100. After this step S2107, the processing goes to step S2108.

In step S2108, when the radio base station 2100 receives the request for the high-speed communication from the radio terminal #2 after the notification in step S2107, the processing goes to step S2109. On the other hand, if the radio base station 2100 does not receive the request for the high-speed communication within a predetermined period from the radio terminal #2, or if a notice of not requesting the high-speed communication is received from the radio terminal #2, the processing goes to step S2113. Here, the “predetermined period” is set up as desired depending on the system, and is measured by a timer (not shown) provided in the controller 2140 of the radio base station 2100.

In step S2109, the radio base station 2100 reduces the transmission power for the radio terminal #1, and increases the transmission power for the radio terminal #2.

In step S2110, the radio base station 2100 acquires the CNR of the radio terminal #2 again. Specifically, the radio base station 2100 judges whether the CNR of the radio terminal #2 is improved by increasing the transmission power for the radio terminal #2.

In step S2111, the radio base station 2100 judges whether it is possible to raise the downlink modulation class of the radio terminal #2. Specifically, if the CNR is still, short of the required CNR even after increasing the transmission power for the radio terminal #2, the processing goes to step S2113 considering that it is not possible to raise the downlink modulation class of the radio terminal #2. On the other hand, when it is possible to raise the downlink modulation class of the radio terminal #2, the communication is executed in the modulation class at the maximum transfer rate that meets the required CNR.

In step S2114, the radio base station 2100 judges whether to terminate the communication with the radio terminal #2. The processing is terminated when the communication with the radio terminal #2 is terminated. The processing returns to step S2101 when the communication with the radio terminal #2 is not terminated.

(5.2) Interference Judgment Operation by Radio Base Station

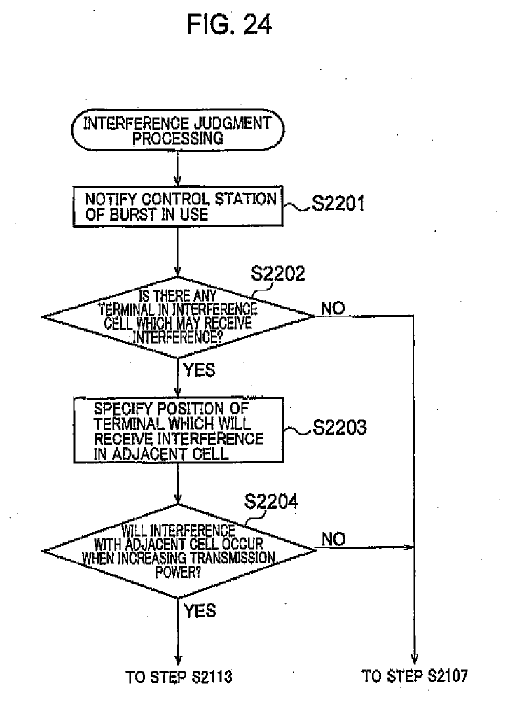

FIG. 24 is a flowchart showing the interference judgment operation by the radio base station 2100. In step S201, the radio base station 2100 notifies a control station (a higher-level device of the radio base station 2100) of the burst (the frequency and the timing) assigned to the radio terminal #2.

In step S2202, upon receipt of the notice from the radio base station 2100, the control station judges whether there is the radio terminal #3 in the adjacent cell which uses the same frequency at the same timing as the radio terminal #2.

In step S2203, the control station request a radio base station communicating with the radio terminal #3 to acquire positional information of the radio terminal #3. The positional information of the radio terminal #3 is acquired based on positional information using the GPS, the transmission power of the radio base station 2100 or the reception power of the radio terminal #3, or the like, for example. The acquired positional information is notified to the radio base station 2100. In step S2204, the radio base station 2100 judges whether the increase in the downlink transmission power for the radio terminal #2 will cause interference with the radio terminal #3 based on the downlink transmission power of the radio terminal #2 and the positional information acquired in step S2203.

(6) Effects and Advantages

As described above, according to the second embodiment, when the judgment is made that it is possible to reduce the transmission power of the radio signal to be transmitted to the radio terminal #1, the radio base station operates as follows. When the sum of the transmission power at timing of transmitting the radio signals to the radio terminals #1 and #2 reaches the threshold, the radio base station 2100 is able not only to reduce the transmission power of the radio signal to be transmitted to the radio terminal #1 but also to increase the transmission power for the radio terminal #2 which desires the increase in the transmission power, even in such a situation.

Therefore, even when the amplifier in the transmitter of the radio base station 2100 is close to saturation, it is still possible to reduce the transmission power of the radio signal to be transmitted to the radio terminal executing the communication at a low data rate (the radio terminal #1) and to increase the transmission power of the radio signal to be transmitted to the radio terminal having the low reception quality (the radio terminal #2).

Moreover, according to the second embodiment, the radio base station 2100 acquires the CNR of the radio signals received by the radio terminals #1 and #2, and determines the modulation classes to be applied to the radio signals to be transmitted to the radio terminals #1 and #2, respectively, in accordance with the acquired reception quality.

Therefore, the CNR of the radio terminal #2 is improved by increasing the transmission power of the radio signal to be transmitted to the radio terminal #2. Thus, it is possible to raise the modulation class to be applied to the radio signal to be transmitted to the radio terminal #2. As a result, the radio terminal #2 is able to execute an application such as video streaming, which requires a high-speed communication rate.

According to the second embodiment, the radio base station 2100 judges that it is possible to reduce the transmission power of the radio signal to be transmitted to the radio terminal #1 when the reception quality of the radio signal received by the radio terminal #1 is higher than the required CNR of the modulation class applied to the radio signal to be transmitted to the radio terminal #1.

Specifically, deterioration in the communication quality of the radio terminal #1 is avoided by reducing the transmission so power for the radio terminal #1 only when the CNR of the radio terminal #1 is equal to or higher than a necessary level.

Moreover, according to the second embodiment, the radio base station 2100 increases the transmission power of the radio signal to be transmitted to the radio terminal #2, when it is judged that the radio signal to be transmitted to the radio terminal #2 will not interfere with the radio terminal #3 located inside the adjacent cell.

Therefore, even if the transmission power of the radio signal to be transmitted to the radio terminal #2 is increased, it is still possible to prevent the radio signal from interfering with the radio terminal #3 located inside the adjacent cell.

### Other Embodiments

Although the present invention has been described above according to the first embodiment and the second embodiment, it is to be understood that the statements and the drawings constituting part of this disclosure will not limit this invention. It is obvious to those skilled in the art that various alternative embodiments, examples, and operation techniques are possible from this disclosure.

For example, in the first embodiment and the second embodiment described above, the transmission power for the radio terminal #1 is reduced, and at the same time, the transmission power for the radio terminal #2 is increased. Instead, the transmission power for the radio terminal #1 may be firstly reduced, and then the transmission power for the radio terminal #2 may be increased after a lapse of a predetermined period.

The first embodiment and the second embodiment described above have been each described as the radio communication system based on the WiMAX standard as an example. However, the radio communication system is not limited to that based on the WiMAX standard. The transmission control method according to the above-described embodiments is applicable to any radio communication system which uses the adaptive modulation. Although the CNR has been used as the reception quality in the first embodiment and the second embodiment described above, it is also possible to use a Signal to Interference and Noise power Ratio (SINR), a Received Signal Strength Indicator (RSSI), a Bit Error Rate (BER), a Frame Error Rate (FER), or the like instead of the CNR.

Accordingly, it is to be understood that the present invention encompasses various embodiments and the like which have not been expressly disclosed herein. Therefore, the present invention is limited only by the features of the invention which are defined by the appended scope claims as being appropriate from this disclosure.

It is to be noted that the entire contents of Japanese Patent Application No. 2007-117793 (filed on Apr. 26, 2007) and of Japanese Patent Application No. 2007-142580 (filed on May 29, 2007) are incorporated herein by reference.

### INDUSTRIAL APPLICABILITY

As described above, according to the radio base station and the transmission control method of the present invention, it is possible to properly control the transmission power for the multiple radio communication terminals even when the amplifier in the transmitter of the radio base station is close to saturation. Hence the present invention is useful for radio communication such as mobile telecommunication.

1. A radio base station which transmits radio signals simultaneously to a plurality of radio communication terminals including a first radio communication terminal and a second radio communication terminal, the radio base station comprising:
an increase request receiver configured to receive, from the first radio communication terminal, an increase request for transmission power of a radio signal to be transmitted to the first radio communication terminal;
a threshold judgment unit configured to judge whether a sum of the transmission power at timing of transmitting the radio signals to the radio communication terminals reaches a threshold, when the increase request receiver receives the increase request;
a reduction judgment unit configured to judge whether it is possible to reduce the transmission power of a radio signal to be transmitted to the second radio communication terminal, when the threshold judgment unit judges that the sum reaches the threshold; and
a transmission power controller configured to reduce the transmission power of the radio signal to be transmitted to the second radio communication terminal and to increase the transmission power of the radio signal to be transmitted to the first radio communication terminal, when the reduction judgment unit judges that it is possible to reduce the transmission power of the radio signal to be transmitted to the second radio communication terminal.

2. The radio base station according to claim 1, further comprising:
a reception quality acquisition unit configured to acquire reception quality of the radio signal received by each of the radio communication terminals; and
a modulation class determination unit configured to determine a modulation class to be applied to the radio signal to be transmitted to each of the radio communication terminals in accordance with the reception quality acquired by the reception quality acquisition unit.

3. The radio base station according to claim 2, wherein the reduction judgment unit judges that it is possible to reduce the transmission power of the radio signal to be transmitted to the second radio communication terminal, when the reception quality of the radio signal received by the second radio communication terminal is higher than required reception quality of the modulation class applied to the radio signal to be transmitted to the second radio communication terminal.

4. The radio base station according to claim 1, further comprising:
an interference judgment unit configured to judge whether the radio signal to be transmitted to the first radio communication terminal will interfere with a radio communication terminal communicating with a different radio base station, if the transmission power of the radio signal to be transmitted to the first radio communication terminal is increased, wherein
the transmission power controller increases the transmission power of the radio signal to be transmitted to the first radio communication terminal, when the interference so judgment unit judges that the radio signal to be transmitted to the first radio communication terminal will not interfere with the radio communication terminal communicating with the different radio base station.

5. A transmission control method using a radio base station which transmits radio signals simultaneously to a plurality of radio communication terminals including a first radio communication terminal and a second radio communication terminal, the transmission control method comprising the steps of:
receiving, from the first radio communication terminal, an increase request for transmission power of a radio signal to be transmitted to the first radio communication terminal;
judging whether a sum of the transmission, power at timing of transmitting the radio signals to the radio communication is terminals reaches a threshold, when receiving the increase request;
judging whether it is possible to reduce the transmission power of a radio signal to be transmitted to the second radio communication terminal, when the sum is judged to reach the threshold;
reducing the transmission power of the radio signal to be transmitted to the second radio communication terminal, when it is judged that it is possible to reduce the transmission power of the radio signal to be transmitted to the second radio communication terminal; and
increasing the transmission power of the radio signal to be transmitted to the first radio communication terminal after reducing the transmission power of the radio signal to be transmitted to the second radio communication terminal.

6. A radio base station which transmits radio signals simultaneously to a plurality of radio communication terminals including a first radio communication terminal and a second radio communication terminal, the radio base station comprising:
a reduction judgment unit configured to judge whether it is possible to reduce transmission power of a radio signal to be transmitted to the first radio communication terminal;
a threshold judgment unit configured to judge whether a sum of the transmission power at timing of transmitting the radio signals to the radio communication terminals reaches a threshold, when the reduction judgment unit judges that it is possible to reduce the transmission power of the radio signal to be transmitted to the first radio communication terminal;
an increase judgment unit configured to judge whether it is possible to increase the transmission power of a radio signal to be transmitted to the second radio communication terminal, when the threshold judgment unit judges that the sum reaches the threshold; and
a transmission power controller configured to reduce the transmission power of the radio signal to be transmitted to the first radio communication terminal, when the increase judgment unit judges that it is possible to increase the transmission power of the radio signal to be transmitted to the second radio communication terminal and when the transmission power of the radio signal to be transmitted to the second radio communication terminal is increased.

7. The radio base station according to claim 6, further comprising:
a reduction request receiver configured to receive, from the first radio communication terminal, a reduction request for the transmission power of the radio signal to be transmitted to the first radio communication terminal, wherein
the reduction judgment unit judges that it is possible to reduce the transmission power of the radio signal to be transmitted to the first radio communication terminal when the reduction request receiver receives the reduction request.

8. The radio base station according to claim 6, further comprising:
a reception quality acquisition unit configured to acquire reception quality of the radio signal received by each of the radio communication terminals; and
a modulation class determination unit configured to determine a modulation class to be applied to the radio signal to be transmitted to each of the radio communication terminals in accordance with the reception quality acquired by the reception quality acquisition unit, wherein
the reduction judgment unit judges that it is possible to reduce the transmission power of the radio signal to be transmitted to the first radio communication terminal, when the reception quality of the radio signal received by the first radio communication terminal is higher than required reception quality of the modulation class applied to the radio signal to be transmitted to the first radio communication terminal.

9. The radio base station according to claim 6, further comprising:
an increase notifier configured to notify the second radio communication terminal of a judgment result when the increase judgment unit judges that it is possible to increase the transmission power of the radio signal to be transmitted to the second radio communication terminal, wherein
the transmission power controller increases the transmission power of the radio signal to be transmitted to the second radio communication terminal and reduces the transmission power of the radio signal to be transmitted to the first radio communication terminal, when the transmission power controller receives from the second radio communication terminal an increase request for the transmission power of the radio signal to be transmitted to the second radio communication terminal as a result of the notification by the increase notifier.

10. The radio base station according to any one of claims 6 to 9, further comprising;
an interference judgment unit configured to judge whether the radio signal to be transmitted to the second radio communication terminal will interfere with a radio communication terminal communicating with a different radio base station, if the transmission power of the radio signal to be transmitted to the second radio communication terminal is increased, wherein
the transmission power controller increases the transmission power of the radio signal to be transmitted to the second radio communication terminal, when the interference judgment unit judges that the radio signal to be transmitted to the second radio communication terminal will not interfere with the radio communication terminal communicating with the different radio base station.

11. A transmission control method using a radio base station which transmits radio signals simultaneously to a plurality of radio communication terminals including a first radio communication terminal and a second radio communication terminal, the transmission control method comprising the steps of:
judging whether it is possible to reduce transmission power of a radio signal to be transmitted to the first radio communication terminal;
judging whether it is possible to increase the transmission power of a radio signal to be transmitted to the second radio communication terminal if it is judged as a result of the judgment that it is possible to reduce the transmission power of the radio signal to be transmitted to the first radio communication terminal, and when a sum of the transmission power at timing of transmitting the radio signals to the radio communication terminals reaches a threshold; and
reducing the transmission power of the radio signal to be transmitted to the first radio communication terminal if it is judged as a result of the judgment that it is possible to increase the transmission power of the radio signal to be transmitted to the second radio communication terminal, and when the transmission power of the radio signal to be transmitted to the second radio communication terminal is increased.
